(19) United States
(12) Patent Application Publication
(10) Pub. No.: US 2026/0099970 A1
(43) Pub. Date: Apr. 9, 2026

(54) STYLE APPLICATION ENGINE

(71) Applicant: ADOBE INC., SAN JOSE, CA (US)

(72) Inventors: Sahil Gupta, San Jose, CA (US); Milin Sudhirbhai Shah, San Jose, CA (US); Ramya Teja Chaparala, Pleasant Hill, CA (US); Kiriakos Michael Potsakis, Oceanside, CA (US); Rachel Sklar, Oakland, CA (US)

(21) Appl. No.: 19/180,786

(22) Filed: Apr. 16, 2025

Related U.S. Application Data
(60) Provisional application No. 63/704,807, filed on Oct. 8, 2024.

(51) Int. Cl. G06T 11/60; G06F 3/0483; G06F 3/04845; G06T 7/90; G06T 11/00

(52) U.S. Cl. CPC G06T 11/60; G06F 3/0483; G06F 3/04845; G06T 7/90; G06T 11/10; G06T 2207/10024

(57) ABSTRACT

A method, apparatus, non-transitory computer readable medium, and system for image generation include obtaining an image and a style guide, where the image depicts an object with a first color and the style guide includes a second color. The second color is selected from the style guide based on a proximity criterion. A modified image is generated based on the image and the second color, wherein the modified image depicts the object with the second color.

### CROSS-REFERENCE TO RELATED APPLICATION

This application claims benefit under 35 U.S.C. § 119 to U.S. Provisional Application No. 63/704,807, filed on Oct. 8, 2024, in the United States Patent and Trademark Office, the disclosure of which is incorporated by reference herein in its entirety.

### BACKGROUND

The following relates generally to document processing, and more specifically to applying style effects to documents. Document processing refers to techniques and processes of editing source documents (digital documents such as presentations, flyers, profile covers). In some cases, modified documents capture content from the source documents and may have different styles than the source documents. Document processing is a combination of natural language processing (NLP) and image processing. For example, image processing is a type of data processing that involves manipulating or generating image data. Recently, machine learning (ML) models have been used in advanced document processing techniques. Among these ML models, transformer networks and generative models such as generative adversarial networks (GANs) have been used for various tasks including recoloring, style transfer, generating images with perceptual metrics, generating images in conditional settings, image manipulation.

### SUMMARY

The present disclosure describes systems and methods for document processing. Embodiments of the present disclosure include a document processing apparatus that applies a style guide (e.g., a brand comprising style related assets) across a source document triggered by receiving a single click input via a user interface. In some examples, the source document includes an entity-component system (ECS) document (documents such as presentations, flyers, Instagram® posts, stories including text animations and multi-frame edits, etc.). In some cases, a single-click (“Apply brand” button) input from a user triggers a process of automatically applying brand-specific colors, fonts, and image recoloring in one action, eliminating the need for manual adjustments. The document processing apparatus improves on creative flexibility through shuffled variations on subsequent clicks and provides efficient undo and redo functionality for rapid toggling between iterations.

A method, apparatus, non-transitory computer readable medium, and system for image processing are described. One or more aspects of the method, apparatus, non-transitory computer readable medium, and system include obtaining an image and a style guide, wherein the image depicts an object with a first color and the style guide includes a second color; identifying a second color from the style guide based on a proximity criterion between the first color and the second color; and generating, using an image generation model, a modified image based on the image and the second color, wherein the modified image depicts the object with the second color.

A method, apparatus, non-transitory computer readable medium, and system for image processing are described. One or more aspects of the method, apparatus, non-transitory computer readable medium, and system include obtaining a document and a style guide, wherein the document includes a text element with a first font and an image depicting an object with a first color, and wherein the style guide includes a second font and a second color; applying the second font from the style guide to the text element to obtain a modified text element; applying the second color from the style guide to the image to obtain a modified image, wherein the modified image depicts the object with the second color; and generating a modified document that includes the modified image and the modified text element.

An apparatus, system, and method for image processing are described. One or more aspects of the apparatus, system, and method include a memory component; a processing device coupled to the memory component, the processing device configured to perform operations comprising: obtaining an image and a style guide, wherein the image depicts an object with a first color and the style guide includes a second color; generating a first color embedding and a second color embedding based on the first color and the second color, respectively; selecting the second color from the style guide by comparing the first color embedding of the first color and the second color embedding of the second color; and generating a modified image based on the image and the second color, wherein the modified image depicts the object with the second color.

### BRIEF DESCRIPTION OF THE DRAWINGS

FIG. 1 shows an example of a document processing system according to aspects of the present disclosure.

FIG. 2 shows an example of a method for single click brand application according to aspects of the present disclosure.

FIG. 3 shows an example of a user interface for style guide application according to aspects of the present disclosure.

FIG. 4 shows an example of effect of applying a style guide according to aspects of the present disclosure.

FIG. 5 shows an example of a style guide including font selection according to aspects of the present disclosure.

FIG. 6 shows an example of effect of applying a font according to aspects of the present disclosure.

FIG. 7 shows an example of recolor images effect according to aspects of the present disclosure.

FIG. 8 shows an example of recolor images effect according to aspects of the present disclosure.

FIG. 9 shows an example of recolor images effect according to aspects of the present disclosure.

FIG. 10 shows an example of a user interface on a mobile device according to aspects of the present disclosure.

FIG. 11 shows an example of a user interface on a mobile device according to aspects of the present disclosure.

FIG. 12 shows an example of a method for image processing according to aspects of the present disclosure.

FIG. 13 shows an example of a document processing apparatus according to aspects of the present disclosure.

FIG. 14 shows an example of a transformer network according to aspects of the present disclosure.

FIG. 15 shows an example of a guided diffusion model according to aspects of the present disclosure.

FIG. 16 shows an example of a color application tool according to aspects of the present disclosure.

FIG. 17 shows an example of a font application tool according to aspects of the present disclosure.

FIG. 18 shows an example of style transformation element and style guide setting according to aspects of the present disclosure.

FIG. 19 shows an example of a user interface according to aspects of the present disclosure.

FIG. 20 shows an example of a style guide according to aspects of the present disclosure.

FIG. 21 shows an example of a method for image processing according to aspects of the present disclosure.

FIG. 22 shows an example of an algorithm according to aspects of the present disclosure.

FIG. 23 shows an example of an algorithm according to aspects of the present disclosure.

FIG. 24 shows an example of text description of a color according to aspects of the present disclosure.

FIG. 25 shows an example of a method for image processing according to aspects of the present disclosure.

FIG. 26 shows an example of a style guide including font selection according to aspects of the present disclosure.

FIG. 27 shows an example of effect of applying a font according to aspects of the present disclosure.

FIG. 28 shows an example of a state change effect according to aspects of the present disclosure.

FIG. 29 shows examples of a state change effect according to aspects of the present disclosure.

FIG. 30 shows an example of a step-by-step procedure for training a machine learning model according to aspects of the present disclosure.

FIG. 31 shows an example of a computing device for image processing according to aspects of the present disclosure.

FIG. 32 shows an example of a diffusion transformer (DiT) architecture according to aspects of the present disclosure.

### DETAILED DESCRIPTION

The present disclosure describes systems and methods for document processing. Embodiments of the present disclosure include a document processing apparatus that applies a style guide (e.g., a brand comprising style related assets) across a source document triggered by receiving a single click input via a user interface. In some examples, the source document includes an entity-component system (ECS) document (documents such as presentations, flyers, Instagram® posts, stories including text animations and multi-frame edits, etc.). In some cases, a single-click (“Apply brand” button) input from a user triggers a process of automatically applying brand-specific colors, fonts, and image recoloring in one action, eliminating the need for manual adjustments. The document processing apparatus improves on creative flexibility through shuffled variations on subsequent clicks and provides efficient undo and redo functionality for rapid toggling between iterations.

Conventional systems involve a time-consuming and inconsistent process of applying brand elements (e.g., colors, fonts, and image adjustments) across digital documents, particularly when dealing with multi-page or multi-slide projects. These systems fail to handle mobile devices, where limited screen size makes manual editing tedious and inefficient. For example, manually applying branding to each element in a document is labor-intensive and time-consuming, leading to inefficiency in workflows. Consequently, user satisfaction is decreased. Additionally, inconsistent application of brand guidelines across different components and pages leads to unprofessional and disjointed results, using conventional systems. Brand identity is important for companies.

Furthermore, mobile devices are increasingly being used for professional tasks, but limited screen space makes editing documents challenging. Users are forced to navigate through cumbersome interfaces to manually adjust brand elements, making mobile editing impractical for users. For example, designers often need to explore different variations of brand elements (e.g., fonts, color schemes), but manually experimenting with these combinations is time-consuming (worse on mobile devices). There is a need for systems and methods that enable for quick testing of variations without breaking brand guidelines.

Embodiments of the present disclosure provide a document processing apparatus for automated application of style guide (e.g., brand elements). The document processing apparatus automates the application of fonts, colors, and images across an entire document with a single click. Accordingly, users save time and effort, and they do not need to manual updates for each element of a source document.

In some embodiments, the document processing apparatus performs context-aware branding that involves a process of detecting font sizes and applying suitable variations. The document processing apparatus includes a machine learning model (e.g., a color matching network) that generates color embeddings and computes cosine similarity for color matching. The document processing apparatus provides a level of precision and ensures improved alignment with brand guidelines and enhances visual consistency.

In some embodiments, the document processing apparatus performs dynamic image recoloring by using a custom generative model or API for intelligent image recoloring. The document processing apparatus provides selective recoloring that preserves image quality while ensuring brand compliance. Additionally, the document processing apparatus performs shuffling and includes synchronization features, which involve a process of shuffling brand variations and synchronizing colors across multiple pages or slides. Accordingly, creative flexibility (e.g., integration and dynamic adjustment) is improved while maintaining brand integrity.

Embodiments of the present disclosure can be implemented on mobile devices having relatively small screen size, making it more accessible and user-friendly for mobile professionals (e.g., prioritize mobile usability, increase their effectiveness in today's multi-device environment).

Embodiments of the present disclosure provide an adaptive single-click system that applies brand elements (e.g., colors, fonts, and image recoloring) across entire multi-page documents with one action, ensuring consistent and context-aware branding. The single-click system incorporates a shuffle feature for quickly generating brand-compliant variations, and its undo and redo functions lead to seamless iteration (e.g., beneficial to mobile users where screen space is limited. The combination of automation, flexibility, and mobile optimization improves workflow efficiency compared to existing manual methods.

The document processing apparatus can be deployed across user devices having different screen sizes, including mobile devices. By condensing multiple manual tasks into a single click and undo/redo, the document processing apparatus provides an intuitive and smooth user experience regardless of devices. The document processing apparatus provides consistent results that require little to no manual adjustments.

The present disclosure describes systems and methods that improve on conventional document processing models by increasing the efficiency of applying colors to one or more objects in an input image. For example, users provide an image including a target object, select “applying colors” parameter, and click on a button to apply brand to the input image. The dynamic brand identity color matching system (DBICMS), using a machine learning model, computes embeddings of candidate colors from a style guide, and compares these color embeddings to a color embedding of an object in the input image. Therefore, efficiency of applying colors to the objects in the input image is improved. In addition, contextual compatibility among the objects in the input image is improved because desired colors from the style guide are applied to the objects to ensure brand consistency.

The term “image” refers to a pixel based image, a vector image, a media content item, or a page of a multi-media document. In some examples, an input document includes a set of slide decks, and each page of the slide decks may be referred to as an image. The image may include one or more media elements such as text element, image element, static element, animated element, etc. The term “modified image” refers to a modified pixel based image, a modified vector image, a modified media content item, or a modified page of a multi-media document after applying a style guide operation to an original image. A modified image is used to distinguish itself from the original image. Compared to the original image, the modified image may include a different font style, font color, and/or size corresponding to a text element. Additionally or alternatively, the modified image may include a different graphics color corresponding to an image element than that of the original image.

The term “style guide” refers to a collection of style related features and assets including a font, a text color, a background color, a logo, or any combination thereof. A style guide is related to a predetermined theme or a brand. The style guide can be modified, e.g., adding/removing font style from the style guide font pool, adding/removing color from the style guide color palette. The style guide can be applied to a single page of an input document (e.g., multi-page flyers) or all pages of the input document. In some cases, a style guide may refer to an image editing tool or interface where a user applies style guide to an input image.

The term “color embedding” refers to the representation of colors in a numerical space, for example, as vectors in a multi-dimensional embedding space. A machine learning model is trained to encode color information in a way that captures relationships and similarities between different colors. In some examples, the machine learning model takes an input prompt including a color phrase describing an object and generates a color embedding based on the input prompt. Alternatively, the machine learning model takes an input prompt including an image depicting an object and generates a color embedding based on the input prompt. In some cases, colors are embedded in various spaces, such as RGB, Lab, or learned color embedding. A learned color embedding maps colors into a multi-dimensional space where colors that are perceptually similar are closer together.

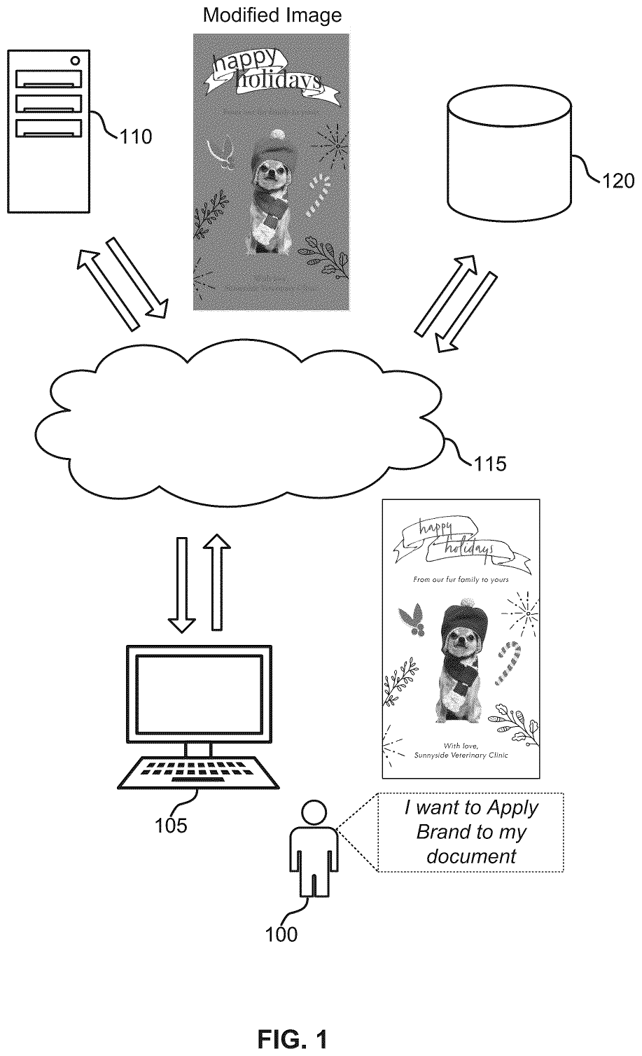

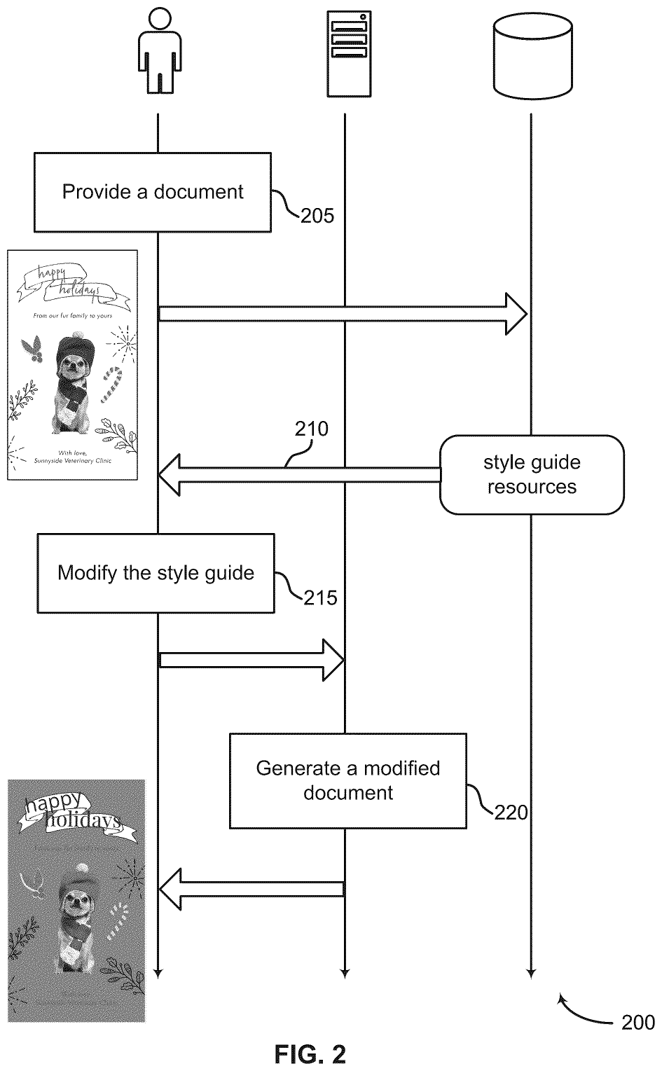

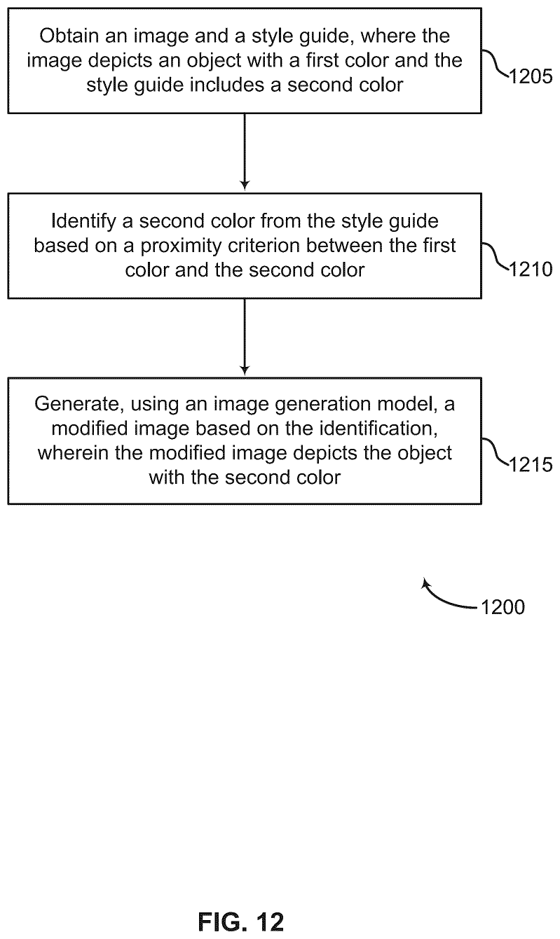

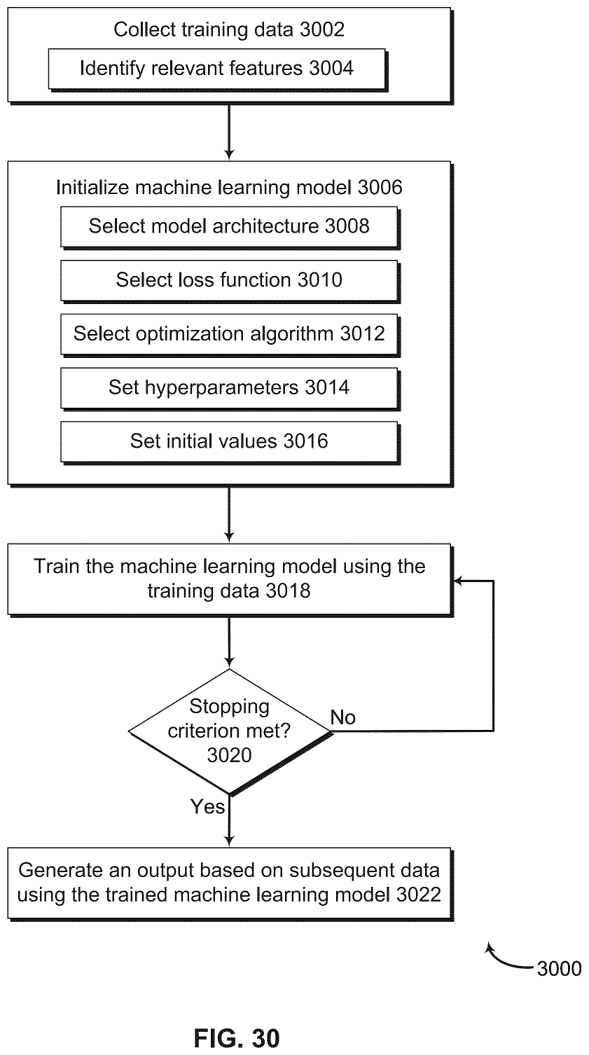

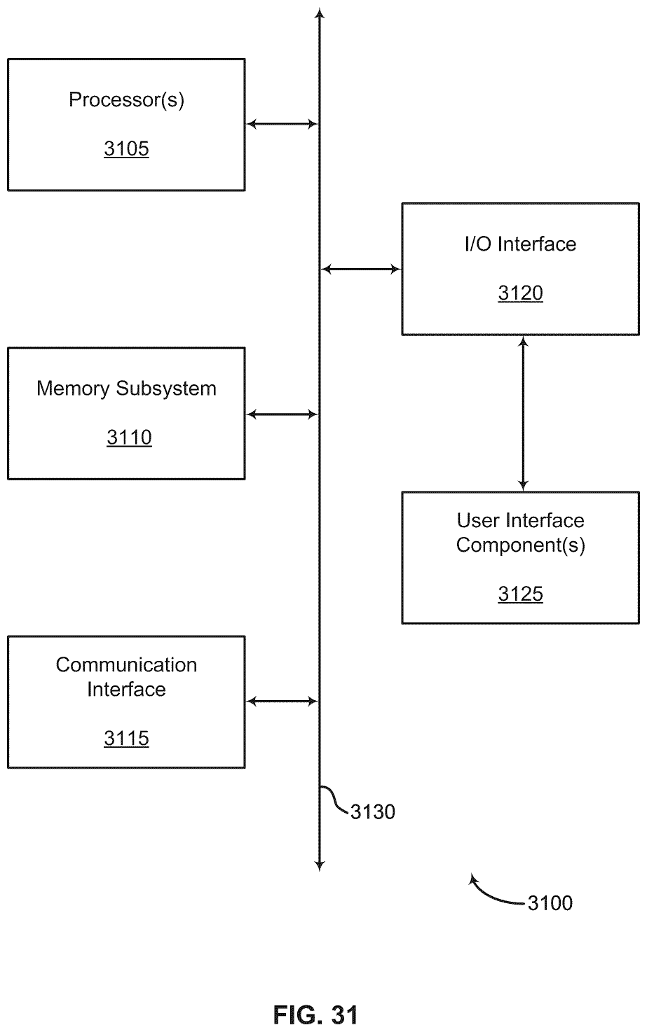

Embodiments of the present disclosure have applications in document processing such as changing fonts, applying colors, recoloring graphics of an input document. Examples of application in document processing context are provided with reference to FIGS. 2-11. Details regarding the architecture of an example document processing system are provided with reference to FIGS. 1 and 13-20. Details regarding the various processes (e.g., changing fonts, applying colors, recoloring graphics) are provided with reference to FIGS. 12 and 21-29. Details regarding an example of training a machine learning model are provided with reference to FIG. 30. Details regarding a computing device for document processing are provided with reference to FIG. 31.

### Document and Image Processing

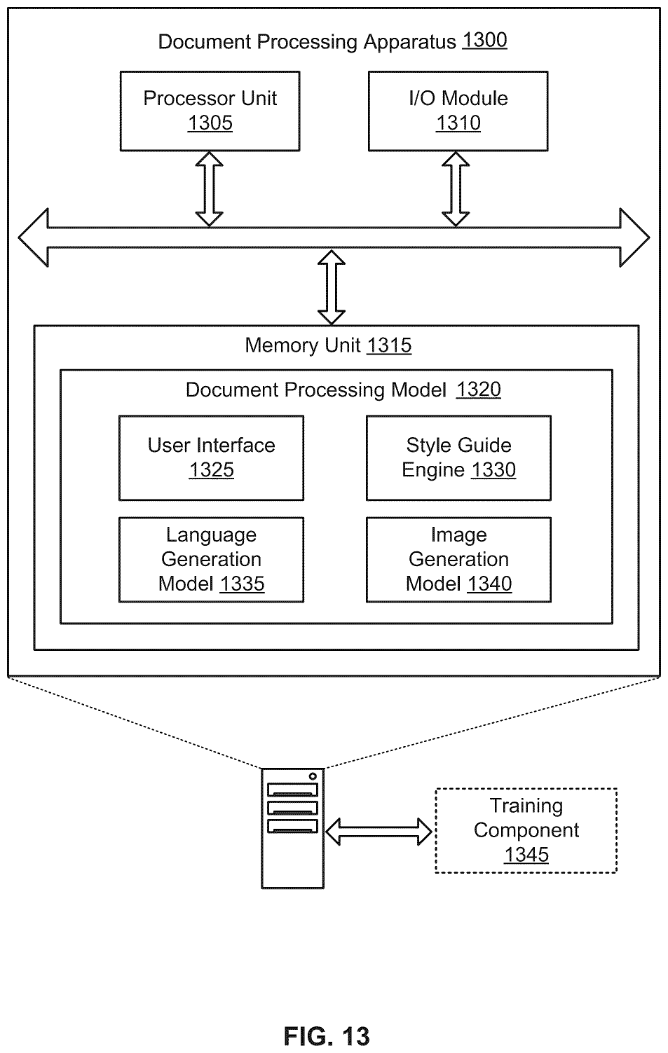

FIG. 1 shows an example of a document processing system according to aspects of the present disclosure. The example shown includes user 100, user device 105, document processing apparatus 110, cloud 115, and database 120. Document processing apparatus 110 is an example of, or includes aspects of, the corresponding element described with reference to FIG. 13.

In an example shown in FIG. 1, an input image is provided by user 100. The input image depicts a dog wearing a scarf and a hat. The scarf and the hat are red. The input image includes text (e.g., “happy holidays”) in a first font. In some cases, a style guide is provided to user 100 on an image editing user interface. The user 100 wants to apply a style guide to the input image by clicking on “Apply brand” button. The input image is transmitted to document processing apparatus 110, e.g., via user device 105 and cloud 115.

Document processing apparatus 110 generates a first color embedding based on the color of the scarf (i.e., red). Document processing apparatus 110 generates a second color embedding based on a second color from the style guide (e.g., a brand related color such as green). The second color (green) is selected from the style guide by comparing the first color embedding of the color of scarf and the second color embedding of the second color. In some examples, a second font is selected from the style guide and applied to “happy holidays” based on a font size of “happy holidays” relative to a font size of other text in the input image. Document processing apparatus 110 returns a modified image to user 100 via cloud 115 and user device 105. The modified image depicts the dog with the second color (green) and includes modified text “happy holidays” in the second font.

User device 105 may be a personal computer, laptop computer, mainframe computer, palmtop computer, personal assistant, mobile device, or any other suitable processing apparatus. In some examples, user device 105 includes software that incorporates an image processing application (e.g., an image generator, an image editing tool). In some examples, the image processing application on user device 105 may include functions of document processing apparatus 110.

A user interface may enable user 100 to interact with user device 105. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a user interface may be represented in code which is sent to the user device 105 and rendered locally by a browser.

Document processing apparatus 110 includes a computer-implemented network comprising a user interface, a style guide engine, a language generation model, and an image generation model. Document processing apparatus 110 may also include a processor unit, a memory unit, an I/O module, and a user interface. A training component may be implemented on an apparatus other than document processing apparatus 110. The training component is used to train a machine learning model. Additionally, document processing apparatus 110 can communicate with database 120 via cloud 115. In some cases, the architecture of the document processing model is also referred to as a network, a machine learning model, or a network model. Further detail regarding the architecture of document processing apparatus 110 is provided with reference to FIGS. 13-20. Further detail regarding the operation of document processing apparatus 110 is provided with reference to FIGS. 2, 12 and 21-29.

In some cases, document processing apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

The document processing apparatus 110 may include an artificial neural network (ANN) for applying a style guide to input content (e.g., apply or match color, recolor graphics). An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms (e.g., selecting the max from the inputs as the output) or any other suitable algorithm for activating the node. Each node and edge is associated with one or more node weights that determine how the signal is processed and transmitted.

Cloud 115 is a computer network configured to provide on-demand availability of computer system resources, such as data storage and computing power. In some examples, cloud 115 provides resources without active management by the user. The term “cloud” is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

Database 120 is an organized collection of data. For example, database 120 stores data (e.g., dataset for training a machine learning model) in a specified format known as a schema. Database 120 may be structured as a single database, a distributed database, multiple distributed databases, or an emergency backup database. In some cases, a database controller may manage data storage and processing in database 120. In some cases, a user interacts with the database controller. In other cases, database controllers may operate automatically without user interaction.

FIG. 2 shows an example of a method 200 for single click brand application according to aspects of the present disclosure. In some examples, method 200 describes an operation of the document processing model 1320 described with reference to FIG. 13. In some examples, these operations are performed by a system including a processor executing a set of codes to control functional elements of an apparatus such as the document processing apparatus described in FIG. 1.

Additionally or alternatively, steps of the method 200 may be performed using special-purpose hardware. Generally, these operations are performed according to the methods and processes described in accordance with aspects of the present disclosure. In some cases, the operations described herein are composed of various substeps or are performed in conjunction with other operations.

At operation 205, the user provides an image. In some cases, the operations of this step refer to, or may be performed by, a user as described with reference to FIG. 1. In some cases, the image is from an input document. The input document may include a video having a set of frames, and the image refers to one of the frames of the video.

At operation 210, the user obtains style guide resources from a database. In some cases, the operations of this step refer to, or may be performed by, a user as described with reference to FIG. 1. In some cases, the image depicts a first color and the style guide includes at least one color that is different from the first color. In some examples, the style guide includes a font, a text color, a background color, a logo, or any combination of them.

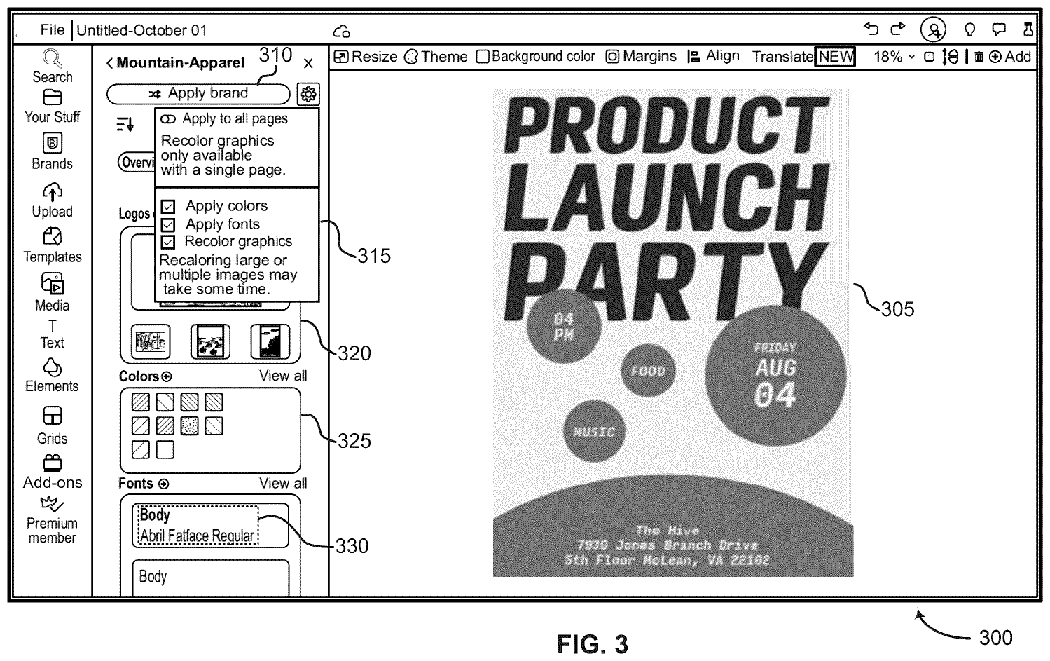

At operation 215, the user modifies the style guide. In some examples, the user creates or edits a style guide by selecting a font from a set of candidate fonts, a color from a set of candidate colors, or a logo from a set of candidate logos. In some cases, the operations of this step refer to, or may be performed by, a user as described with reference to FIGS. 1 and 3.

At operation 220, the system generates a modified image based on the modified style guide. In some cases, the operations of this step refer to, or may be performed by, a document processing apparatus as described with reference to FIGS. 1 and 13. In some cases, the modified image depicts the object with the second color from the style guide. In some cases, the system receives a single click input via a style transformation element, where the modified image is generated based on the single click input. In some cases, the system generates a modified document including the modified image. In some cases, the system applies a first font from the style guide to a first text element of the document and a second font (different from the first font) from the style guide to a second text element of the document.

FIG. 3 shows an example of a user interface 300 for style guide application according to aspects of the present disclosure. The example shown includes user interface 300, image 305, style transformation element 310, style guide setting element 315, candidate logos 320, candidate colors 325, and candidate fonts 330.

According to some embodiments, user interface 300 obtains an image 305 and a style guide, where the image 305 depicts an object with a first color and the style guide includes a second color. In some examples, user interface 300 provides a style transformation element 310 in a user interface 300. In some examples, user interface 300 receives a single click input via the style transformation element 310, where the modified image is generated based on the single click input. In some examples, user interface 300 identifies a color application parameter, where the second color is selected based on the color application parameter. In some examples, user interface 300 receives a page selection input.

According to some embodiments, user interface 300 obtains a document and a style guide, where the document includes a text element with a first font and an image 305 depicting an object with a first color, and where the style guide includes a second font and a second color. In some examples, user interface 300 provides a style transformation element 310 in a user interface 300. In some examples, user interface 300 receives a single click input via the style transformation element 310, where the modified image is generated based on the single click input. In some examples, user interface 300 receives a page selection input.

In an example shown in FIG. 3, user interface 300 displays a page of a document before applying a style guide (e.g., a brand asset collection).

According to some embodiments, user interface 300 receives a user input including a request to apply the style guide to the document. In some examples, document processing model 1320 (as described in FIG. 13) provides a style transformation element in user interface 300. User interface 300 receives a single click input via the style transformation element, where the modified document is generated based on the single click input. In some examples, user interface 300 obtains a selection parameter corresponding to a style attribute from the style guide, where the style attribute is applied to the document based on the selection parameter. In some examples, user interface 300 obtains a color palette, where the style guide includes the color palette.

In some examples, user interface 300 provides a style guide application tool to a user. User interface 300 receives style guide application input via the style guide application tool, where the style guide is based on the style guide application input. In some examples, user interface 300 provides a state change element in a user interface 300. User interface 300 receives a state change input via the state change element, where the modified document is generated based on the state change input. In some examples, user interface 300 receives a setting.

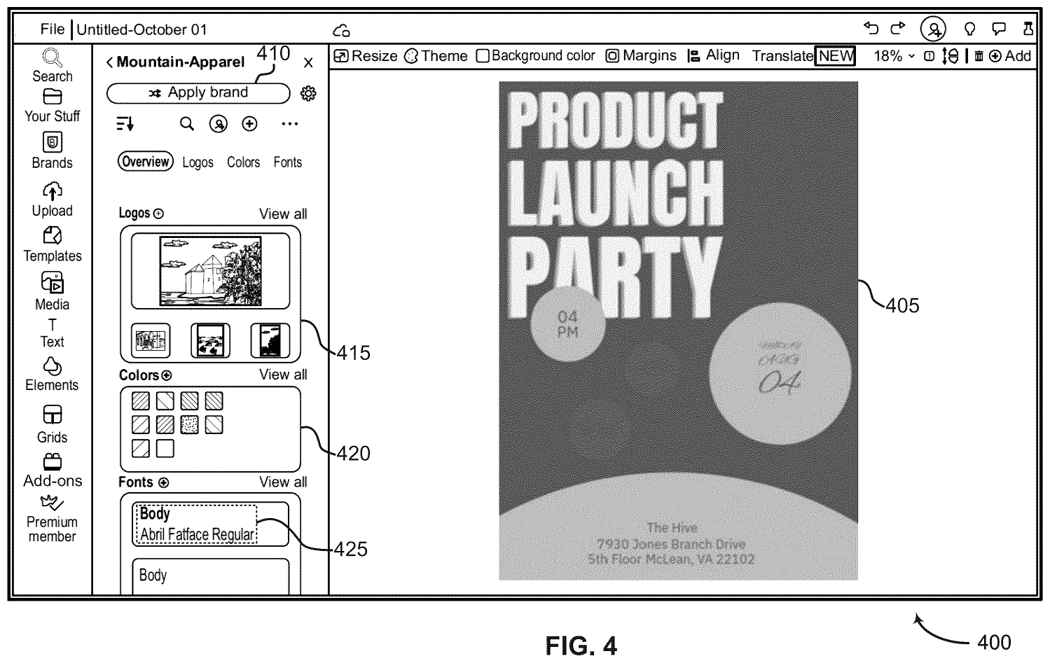

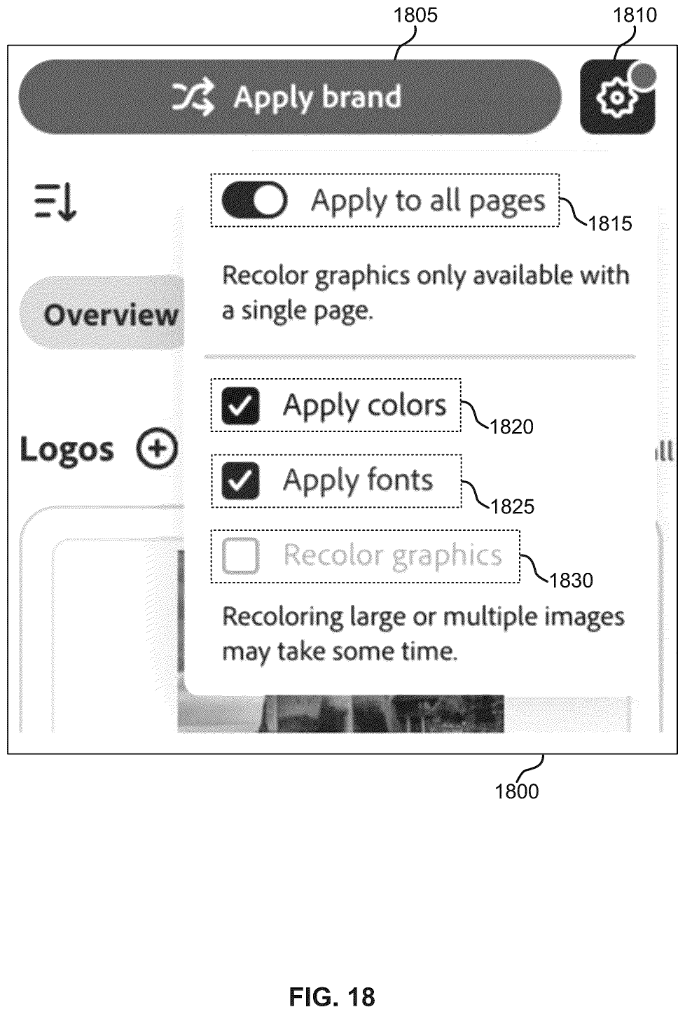

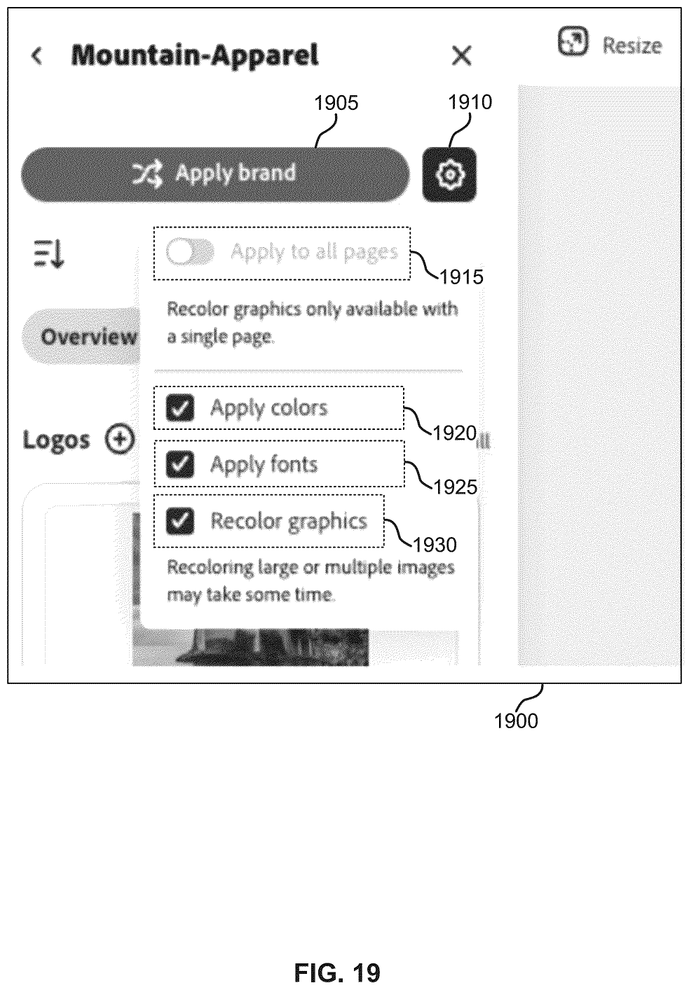

User interface 300 is an example of, or includes aspects of, the corresponding element described with reference to FIGS. 4-11, 13, 18, 19, and 26-29. Style transformation element 310 is an example of, or includes aspects of, the corresponding element described with reference to FIGS. 4, 6-11, 18, 19, 26, and 27. Style guide setting element 315 is an example of, or includes aspects of, the corresponding element described with reference to FIGS. 18 and 19. Candidate logos 320 is an example of, or includes aspects of, the corresponding element described with reference to FIG. 4. Candidate colors 325 is an example of, or includes aspects of, the corresponding element described with reference to FIGS. 4, 7-11, and 20. Candidate fonts 330 is an example of, or includes aspects of, the corresponding element described with reference to FIGS. 4, 26, and 27.

FIG. 4 shows an example of effect of applying a style guide according to aspects of the present disclosure. The example shown includes user interface 400, modified image 405, style transformation element 410, candidate logos 415, candidate colors 420, and candidate fonts 425. User interface 400 is an example of, or includes aspects of, the corresponding element described with reference to FIGS. 3, 5-11, 13, 18, 19, and 26-29.

In an example shown in FIG. 4, user interface 400 displays a modified page of the document mentioned in FIG. 3 after applying a style guide (e.g., a brand asset collection). The colors and fonts are selected from the style guide (the brand asset collection) located on the left-hand region of user interface 400.

Style transformation element 410 is an example of, or includes aspects of, the corresponding element described with reference to FIGS. 3, 6-11, 18, 19, 26, and 27. Candidate logos 415 is an example of, or includes aspects of, the corresponding element described with reference to FIG. 3. Candidate colors 420 is an example of, or includes aspects of, the corresponding element described with reference to FIGS. 3, 7-11, and 20. Candidate fonts 425 is an example of, or includes aspects of, the corresponding element described with reference to FIGS. 3, 26, and 27.

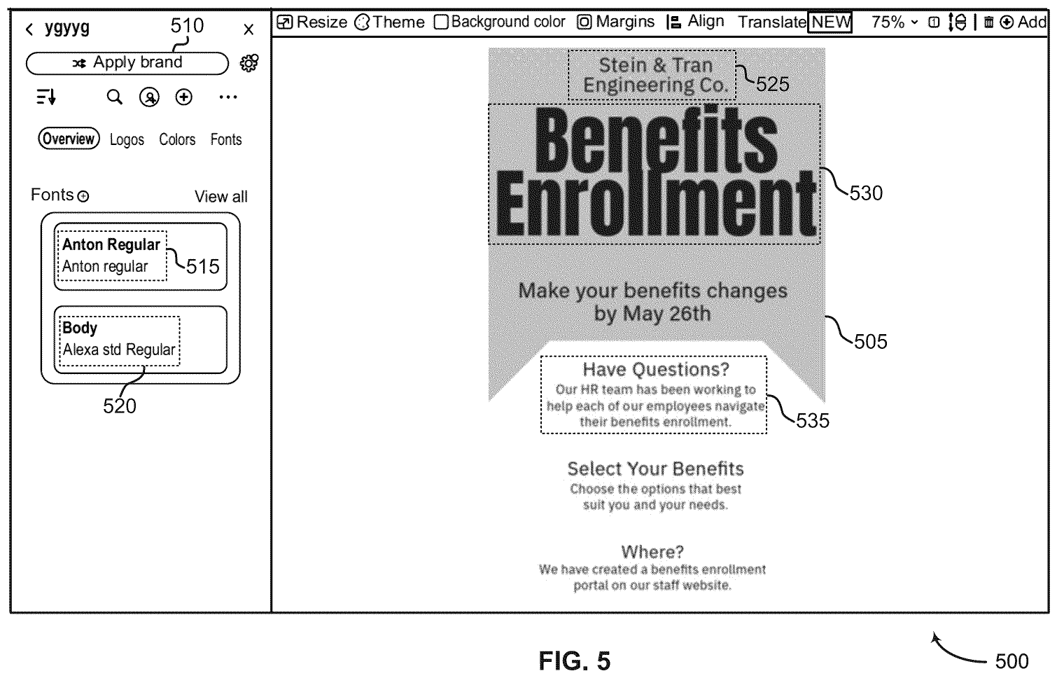

FIG. 5 shows an example of a style guide including font selection according to aspects of the present disclosure. The example shown includes user interface 500, document 505, style transformation element 510, first font 515, second font 520, first text element 525, second text element 530, and third text element 535. User interface 500 is an example of, or includes aspects of, the corresponding element described with reference to FIGS. 3, 4, 6-11, 13, 18, 19, and 26-29.

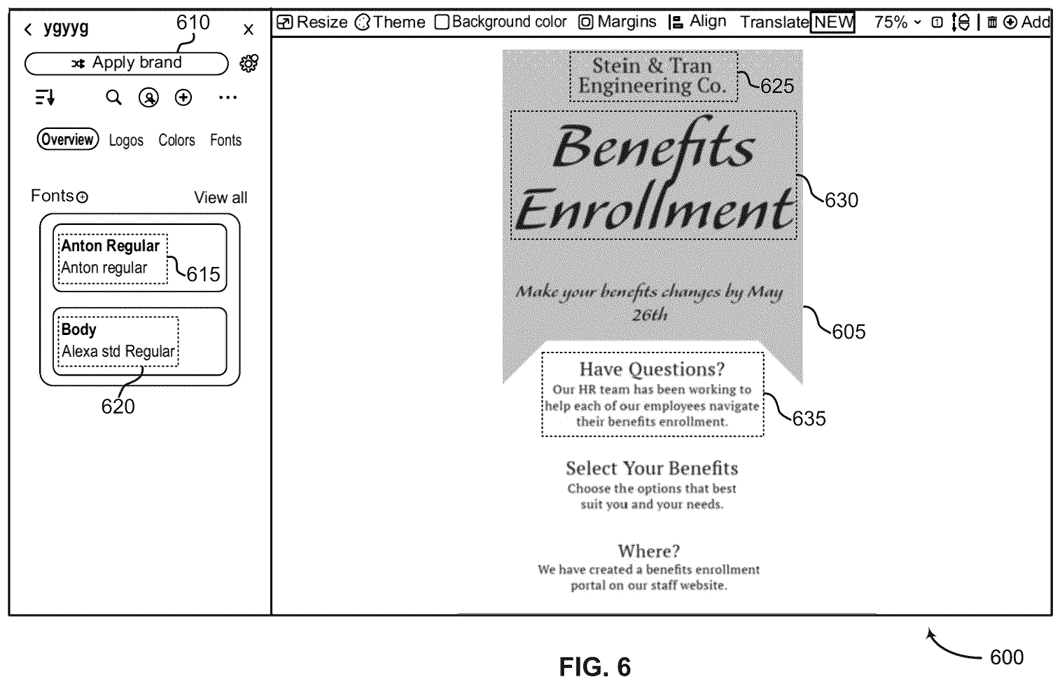

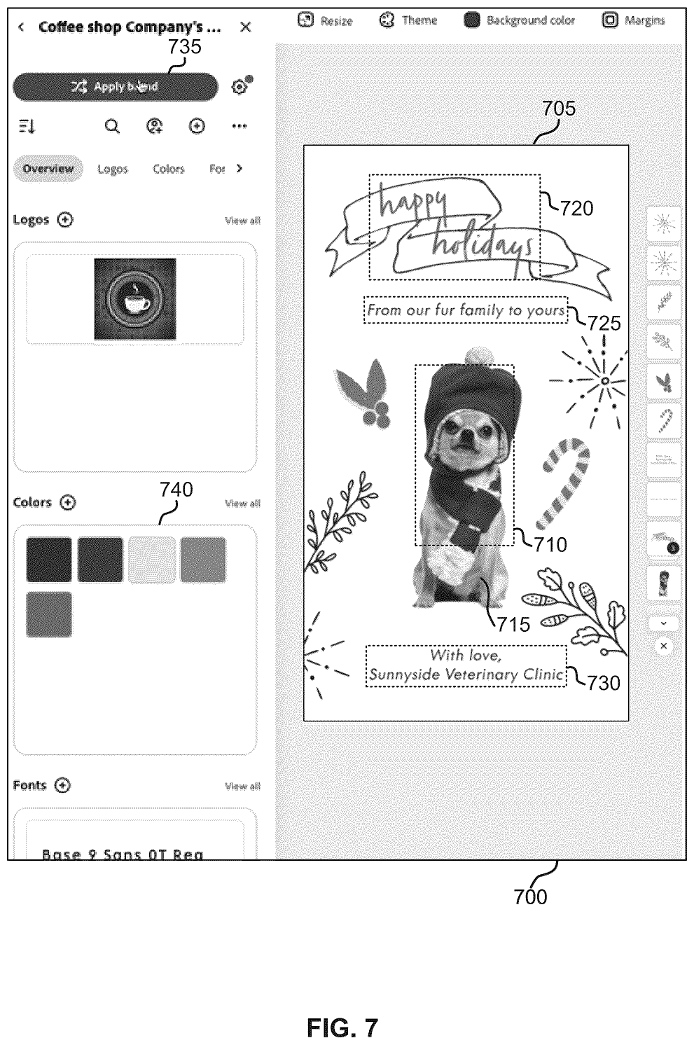

FIG. 5 shows a page of a document before applying font to the document via user interface 500. Document 505 is an example of, or includes aspects of, the corresponding element described with reference to FIGS. 7, 10, and 26. First font 515 is an example of, or includes aspects of, the corresponding element described with reference to FIGS. 6, 20, 26, and 27. Second font 520 is an example of, or includes aspects of, the corresponding element described with reference to FIGS. 6, 20, 26, and 27. In some examples, the first font 515 that is marked as the header (i.e., header role font) in the style guide is different from a current font of the second text element 530 (e.g., a text segment with largest font in the page of the document). In some examples, the second font 520 with body role in the style guide is different from a current font of the first text element 525 (e.g. text with the second largest font). In some cases, the third text element 535 includes the remaining text in the page from document 505.

FIG. 6 shows an example of effect of applying a font according to aspects of the present disclosure. The example shown includes user interface 600, modified document 605, style transformation element 610, first font 615, second font 620, first text element 625, second text element 630, and third text element 635. User interface 600 is an example of, or includes aspects of, the corresponding element described with reference to FIGS. 3-5, 7-11, 13, 18, 19, and 26-29.

FIG. 6 shows a modified page of the document mentioned in FIG. 5 after applying font to the document via a single click on the style transformation element 610 (e.g. the “Apply brand” button) in user interface 600, to obtain modified document 605. The document processing model 1320 (as described in FIG. 13) matches a font from style guide (located on the left-hand region of user interface 600) to a corresponding text segment in the page of the document (i.e., size correspondence). In some examples, a first font 615 that is marked as the header (i.e., header role font) in the style guide is applied to second text element 630 (e.g., a text segment) with the largest font in the page of the document. A second font 620 with body role in the style guide is applied to first text element 625 with the second largest font. In some cases, a third font marked as “None” is applied to third text element 635 (e.g. the remaining text in the page of the document). In some cases, the third font is a default font predefined in the system. After clicking “Apply brand” button, document processing model 1320 applies first font 615 and second font 620 to a respective text element. The modified document 605 includes first text element 625, second text element 630, and third text element 635 in their respective new font style/size. A style guide or a brand may include multiple fonts with the same role. For example, two header fonts, three body fonts. As a result, shuffling a style guide (or a brand), via a single click on the style transformation element 610 in user interface 600, would apply different variations.

The document processing model 1320 obtains a selection parameter corresponding to a style attribute from the style guide, where the style attribute is applied to the document based on the selection parameter to obtain a modified document. In some examples, the document in FIG. 5 and the modified document in FIG. 6 each comprises a multi-media asset.

In some examples, the document processing model 1320 provides seamless undo/redo features, such that users can swiftly toggle between brand variations.

In some embodiments, the document processing model 1320 applies the brand's font variations, categorizing them as headers, body text, or decorative elements based on the brand kit. The document processing model 1320 detects font sizes in an input document and intelligently applies the appropriate font variations in size order, ensuring consistency across all text elements. The document processing model 1320 can detect headings, body and other fonts on the document and intelligently switch them to the right brand font role.

In some embodiments, the document processing model 1320 analyzes the document's existing colors. The document processing model 1320 then applies brand colors using cosine similarity to determine the best match to ensure an optimal color fit within the brand's guidelines.

In some embodiments, the document processing model 1320 selectively recolors specific elements in images, such as turning a non-brand color (e.g., an orange hat) into a brand color (e.g., a brand specified yellow), leveraging an image generation model (or API) for precision recoloring while preserving image integrity.

With regard to multi-page synchronization, the document processing model 1320 ensures that colors remain consistent across all pages or slides, giving the document a cohesive look and feel. In some cases, if there are duplicate slides or pages in the multi-page document, the document processing model 1320 applies the exact same shuffle variations to maintain uniformity across the presentation.

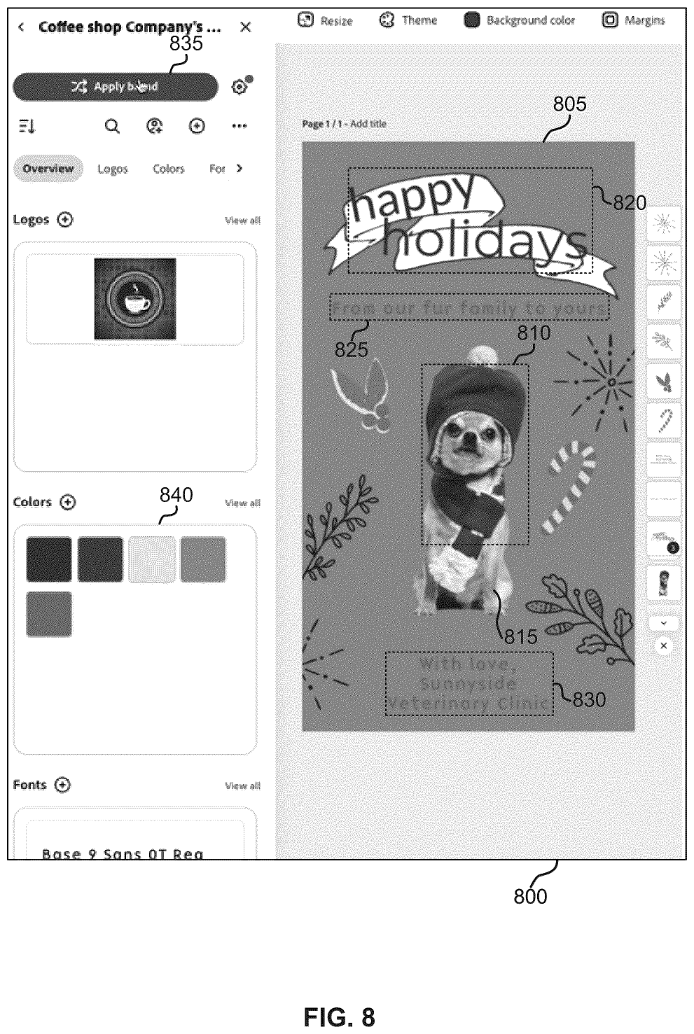

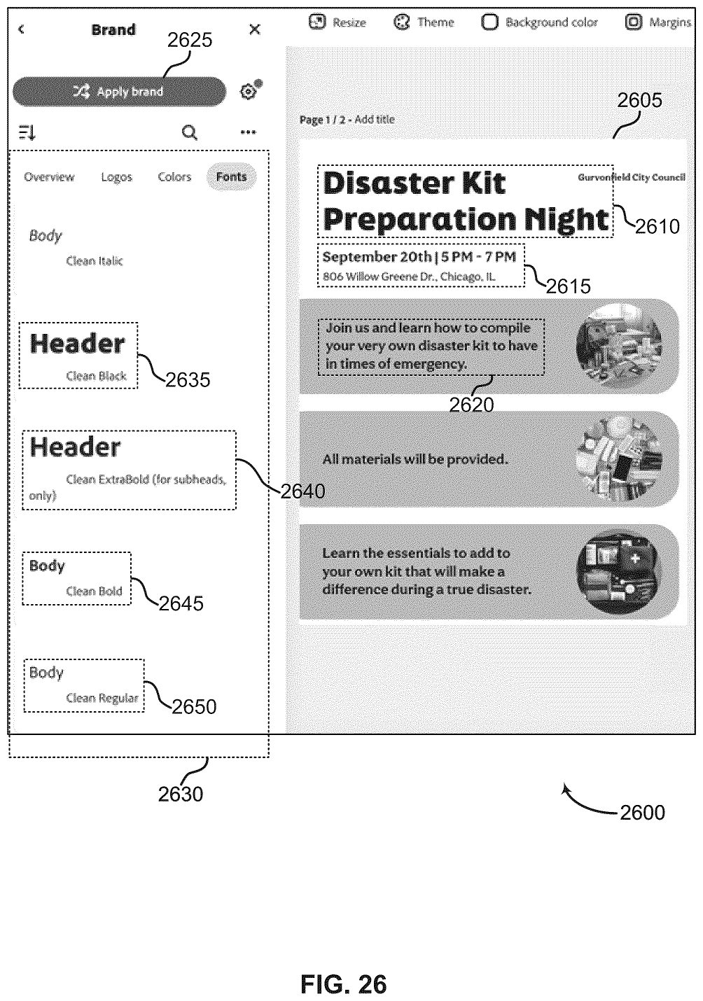

Modified document 605 is an example of, or includes aspects of, the corresponding element described with reference to FIGS. 8, 9, 11, and 27. Style transformation element 610 is an example of, or includes aspects of, the corresponding element described with reference to FIGS. 3, 4, 7-11, 18, 19, 26, and 27. First font 615 is an example of, or includes aspects of, the corresponding element described with reference to FIGS. 5, 6, 20, 26, and 27. Second font 620 is an example of, or includes aspects of, the corresponding element described with reference to FIGS. 5, 6, 20, 26, and 27. First text element 625 is an example of, or includes aspects of, the corresponding element described with reference to FIGS. 7 and 26. Second text element 630 is an example of, or includes aspects of, the corresponding element described with reference to FIGS. 7 and 26. Third text element 635 is an example of, or includes aspects of, the corresponding element described with reference to FIGS. 7 and 26.

FIG. 7 shows an example of recolor images effect according to aspects of the present disclosure. The example shown includes user interface 700, document 705, style transformation element 735, and candidate colors 740. User interface 700 is an example of, or includes aspects of, the corresponding element described with reference to FIGS. 3-6, 8-11, 13, 18, 19, and 26-29.

In one aspect, document 705 includes first image element 710, second image element 715, first text element 720, second text element 725, and third text element 730. Document 705 is an example of, or includes aspects of, the corresponding element described with reference to FIGS. 5, 10, and 26.

First image element 710 is an example of, or includes aspects of, the corresponding element described with reference to FIG. 8. Second image element 715 is an example of, or includes aspects of, the corresponding element described with reference to FIG. 8. First text element 720 is an example of, or includes aspects of, the corresponding element described with reference to FIGS. 6 and 26. Second text element 725 is an example of, or includes aspects of, the corresponding element described with reference to FIGS. 6 and 26. Third text element 730 is an example of, or includes aspects of, the corresponding element described with reference to FIGS. 6 and 26. Style transformation element 735 is an example of, or includes aspects of, the corresponding element described with reference to FIGS. 3, 4, 6, 8-11, 18, 19, 26, and 27. Candidate colors 740 is an example of, or includes aspects of, the corresponding element described with reference to FIGS. 3, 4, 8-11, and 20.

FIG. 8 shows an example of recolor images effect according to aspects of the present disclosure. The example shown includes user interface 800, modified document 805, style transformation element 835, and candidate colors 840. User interface 800 is an example of, or includes aspects of, the corresponding element described with reference to FIGS. 3-7, 9-11, 13, 18, 19, and 26-29.

Modified document 805 includes first image element 810, second image element 815, first modified text element 820, second modified text element 825, and third modified text element 830. For example, user interface 800 displays an image in the middle of a document. The image includes a dog, a scarf, and a hat. The dog wears the scarf and the hat. The scarf and the hat are red.

Modified document 805 is an example of, or includes aspects of, the corresponding element described with reference to FIGS. 6, 9, 11, and 27. First image element 810 is an example of, or includes aspects of, the corresponding element described with reference to FIG. 7. Second image element 815 is an example of, or includes aspects of, the corresponding element described with reference to FIG. 7.

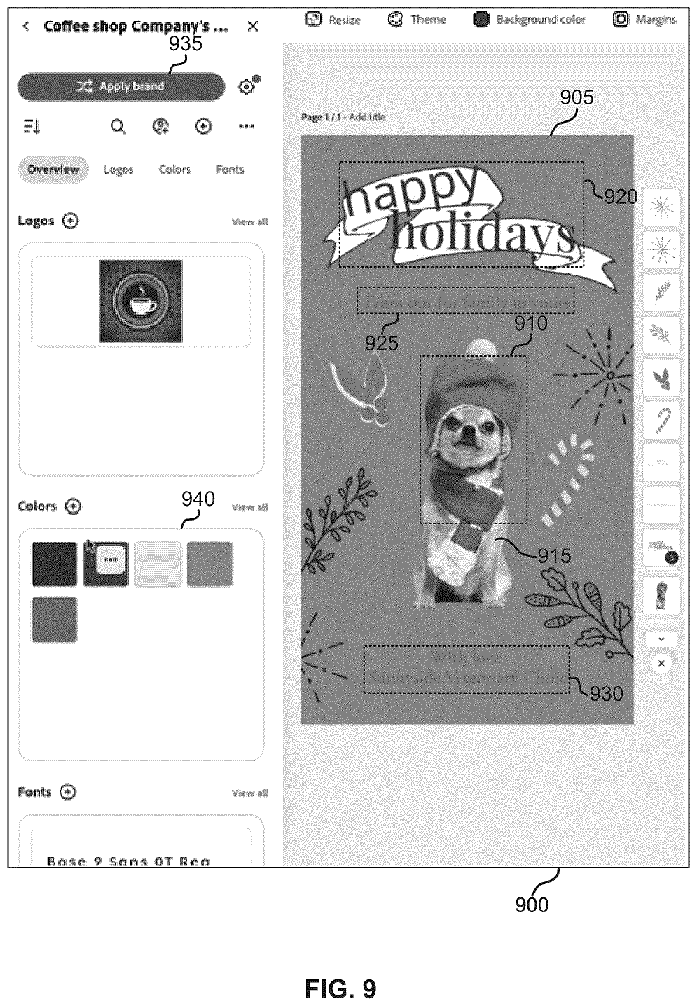

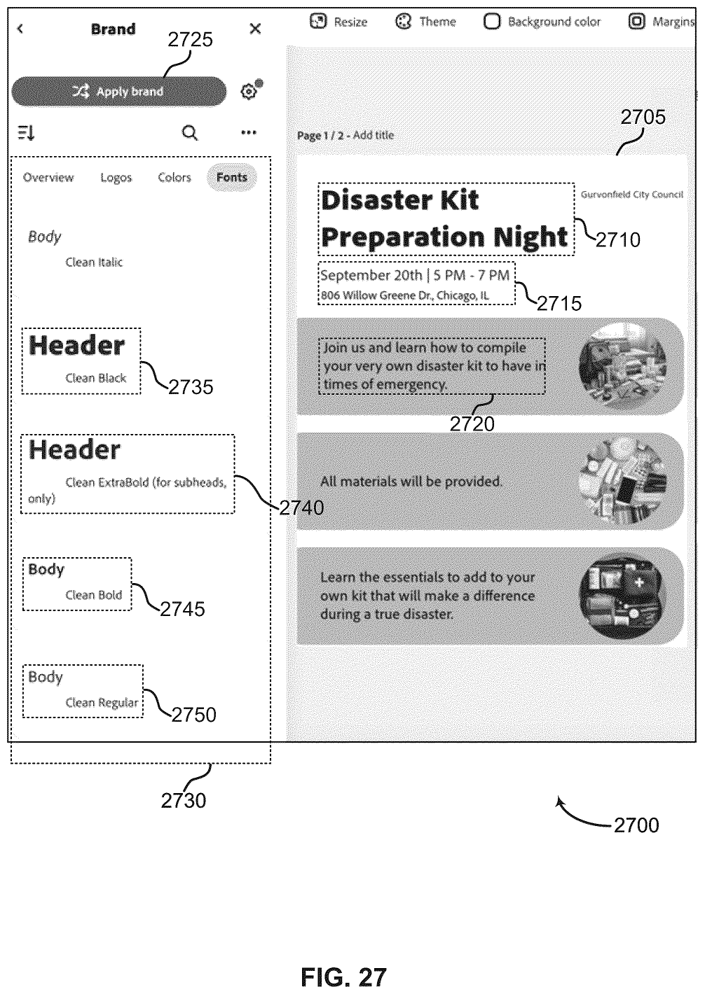

First modified text element 820 is an example of, or includes aspects of, the corresponding element described with reference to FIGS. 9 and 27. Second modified text element 825 is an example of, or includes aspects of, the corresponding element described with reference to FIGS. 9 and 27. Third modified text element 830 is an example of, or includes aspects of, the corresponding element described with reference to FIGS. 9 and 27. Style transformation element 835 is an example of, or includes aspects of, the corresponding element described with reference to FIGS. 3, 4, 6, 7, 9-11, 18, 19, 26, and 27. Candidate colors 840 is an example of, or includes aspects of, the corresponding element described with reference to FIGS. 3, 4, 7, 9-11, and 20.

FIG. 9 shows an example of recolor images effect according to aspects of the present disclosure. The example shown includes user interface 900, modified document 905, style transformation element 935, and candidate colors 940. User interface 900 is an example of, or includes aspects of, the corresponding element described with reference to FIGS. 3-8, 10, 11, 13, 18, 19, and 26-29.

Modified document 905 includes first modified image element 910, second modified image element 915, first modified text element 920, second modified text element 925, and third modified text element 930. For example, a user wants to recolor images in a document. The “recolor graphics” setting is turned on (or activated) via the style guide application tool located on left-hand region of user interface 900. After receiving a single click input on “Apply brand” button, user interface 900 displays a modified document in the right-hand region. The dog in the modified document has the same color as the dog in the input document (see FIG. 8). The color of the scarf and the hat is changed to green (in contrast to red in FIG. 8).

Modified document 905 is an example of, or includes aspects of, the corresponding element described with reference to FIGS. 6, 8, 11, and 27. First modified text element 920 is an example of, or includes aspects of, the corresponding element described with reference to FIGS. 8 and 27. Second modified text element 925 is an example of, or includes aspects of, the corresponding element described with reference to FIGS. 8 and 27. Third modified text element 930 is an example of, or includes aspects of, the corresponding element described with reference to FIGS. 8 and 27. Style transformation element 935 is an example of, or includes aspects of, the corresponding element described with reference to FIGS. 3, 4, 6-8, 10, 11, 18, 19, 26, and 27. Candidate colors 940 is an example of, or includes aspects of, the corresponding element described with reference to FIGS. 3, 4, 7, 8, 10, 11, and 20.

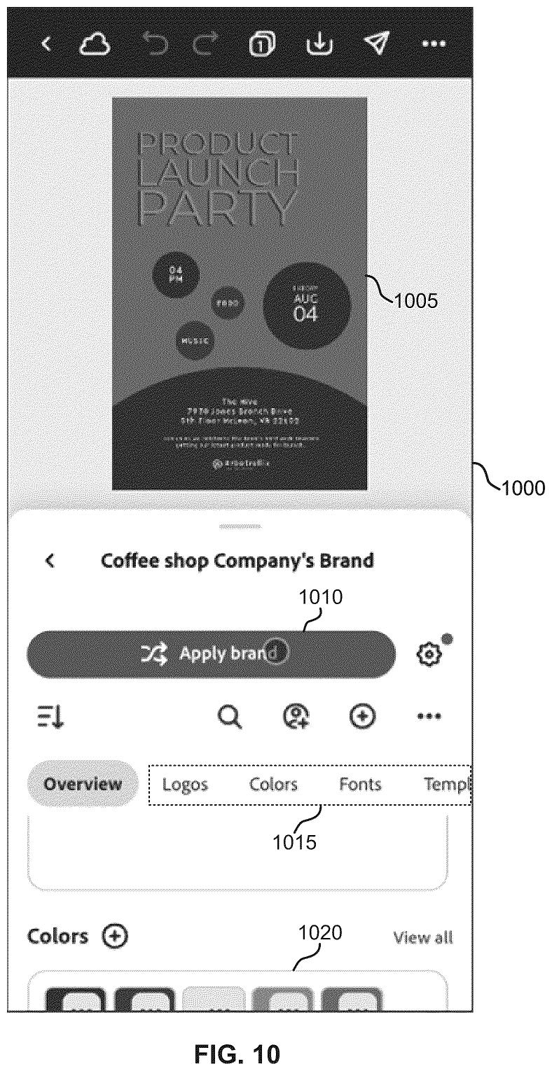

FIG. 10 shows an example of a user interface 1000 on a mobile device according to aspects of the present disclosure. The example shown includes user interface 1000, document 1005, style transformation element 1010, style guide 1015, and candidate colors 1020. User interface 1000 is an example of, or includes aspects of, the corresponding element described with reference to FIGS. 3-9, 11, 13, 18, 19, and 26-29.

FIG. 10 shows an example of a style guide application tool and user interface 1000 implemented on a mobile device having a relatively small screen size. A document 1005 (e.g., input document provided by a user) is displayed on the top half region of user interface 1000. The document 1005 includes text content “product launch party”, date information, patterns, art elements, etc. A user may click on style transformation element 1010 (e.g., “Apply brand” button) to apply the style guide 1015 to modify aspects of document 1005 such as text font, image background color, entity color, etc. User interface 1000 displays candidate colors 1020 at bottom region of the interface. The style guide interface has a vertical spatial arrangement to suit mobile electronic devices.

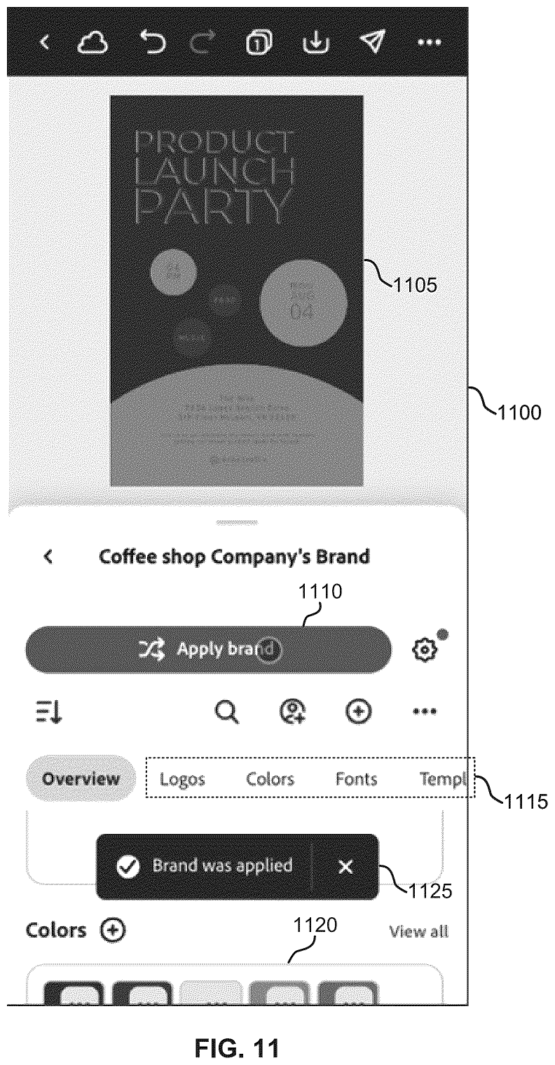

Document 1005 is an example of, or includes aspects of, the corresponding element described with reference to FIGS. 5, 7, and 26. Style transformation element 1010 is an example of, or includes aspects of, the corresponding element described with reference to FIGS. 3, 4, 6-9, 11, 18, 19, 26, and 27. Style guide 1015 is an example of, or includes aspects of, the corresponding element described with reference to FIG. 11. Candidate colors 1020 is an example of, or includes aspects of, the corresponding element described with reference to FIGS. 3, 4, 7-9, 11, and 20.

FIG. 11 shows an example of a user interface 1100 on a mobile device according to aspects of the present disclosure. The example shown includes user interface 1100, modified document 1105, style transformation element 1110, style guide 1115, candidate colors 1120, and message 1125. User interface 1100 is an example of, or includes aspects of, the corresponding element described with reference to FIGS. 3-10, 13, 18, 19, and 26-29.

FIG. 11 shows an example of a style guide application tool and user interface 1100 implemented on a mobile device having a relatively small screen size. User interface 1100 displays a modified document on the top half region of user interface 1100 after receiving a user input (e.g., a single click input via style transformation element 1110 “Apply brand”). The color and font of one or more elements in the previous document (with reference to FIG. 10) are changed based on the style guide to obtain the modified document 1105. For example, text content “product launch party” includes a different color and font than the color and font in the previous document. Art elements (e.g., circles, semicircle) are now orange. User interface 1100 displays candidate colors 1120 at bottom region of the interface and also displays message 1125. The style guide interface has a vertical spatial arrangement to suit mobile electronic devices.

Modified document 1105 is an example of, or includes aspects of, the corresponding element described with reference to FIGS. 6, 8, 9, and 27. Style transformation element 1110 is an example of, or includes aspects of, the corresponding element described with reference to FIGS. 3, 4, 6-10, 18, 19, 26, and 27. Style guide 1115 is an example of, or includes aspects of, the corresponding element described with reference to FIG. 10. Candidate colors 1120 is an example of, or includes aspects of, the corresponding element described with reference to FIGS. 3, 4, 7-10, and 20.

FIG. 12 shows an example of a method 1200 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1205, the system obtains an image and a style guide, where the image depicts an object with a first color and the style guide includes a second color. An example of image is image 305 described in FIG. 3. Style guide is an example of, or includes aspects of, the corresponding element described with reference to FIGS. 3-8, 10-11, 18-19, and 26-27. In some examples, a style guide includes a set of fonts, a set of colors, a set of logos, a set of templates, or any combination thereof. Users can create a new style guide or modify an existing style guide. The second color from the style guide is different from the first color. In some cases, the operations of this step refer to, or may be performed by, a user interface as described with reference to FIGS. 3-11, 13, 18, 19, and 26-29.

At operation 1210, the system identifies a second color from the style guide based on a proximity criterion between the first color and the second color. In some examples, the system generates a first color embedding and a second color embedding based on the first color and the second color, respectively. In some examples, the first color embedding or the second color embedding may refer to representation of the first color or the second color in a vector space. In some cases, the first color embedding and the second color embedding are generated using a language generation model (e.g., LLM). The first color embedding and the second color embedding are used in a contextual brand matching process. In some cases, the operations of this step refer to, or may be performed by, a language generation model as described with reference to FIG. 13.

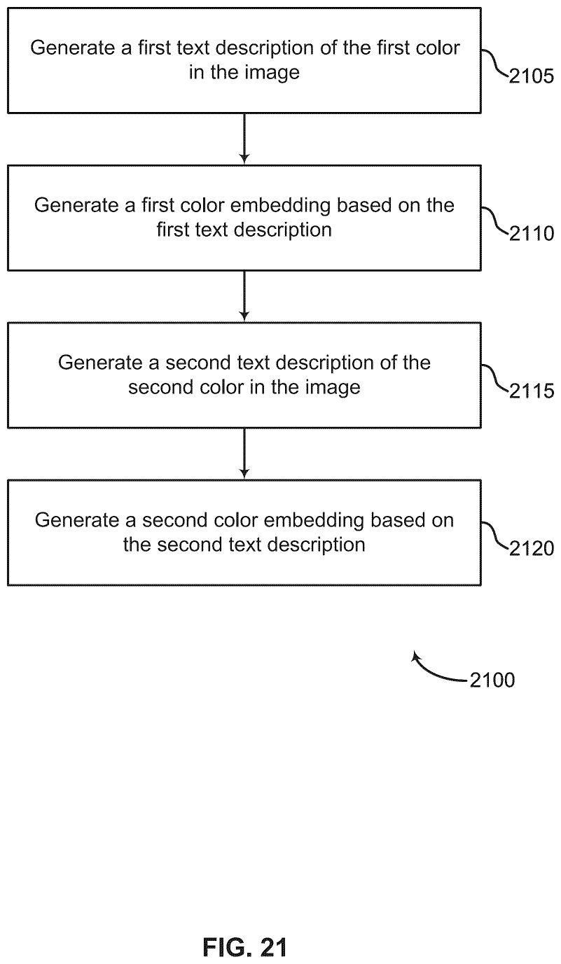

For example, the system can select the second color from the style guide by comparing the first color embedding of the first color and the second color embedding of the second color. In some cases, the operations of this step refer to, or may be performed by, a language generation model as described with reference to FIG. 13. More detail about comparing the first color embedding of the first color and the second color embedding of the second color are described with reference to FIGS. 21-23.

For example, in some cases, the second color from the style guide is selected by identifying the closest color to the first color in an embedding space out of a set of colors from the style guide. In some cases, multiple colors are selected from the style guide based on a relationship between the colors. That is, a relationship between colors in an original image can be maintained instead of selecting the closest color in the embedding space. For example, colors from the style guide can be selected that have a similar degree of contrast to colors in the original image as determined based on the color embeddings.

At operation 1215, the system generates, using an image generation model, a modified image based on the image and the second color, where the modified image depicts the object with the second color. An example of modified image is shown and described with reference to FIGS. 4, 8, 27 and 29, e.g., modified image 405 in FIG. 4. In some cases, the modified image is included in a modified document generated by the system, which applies font and/or color to one or more pages of an input document. An example of modified document is shown and described at least in FIG. 8, i.e., modified document 805. In some cases, the operations of this step refer to, or may be performed by, an image generation model as described with reference to FIG. 13.

In FIGS. 1-12, a method, apparatus, non-transitory computer readable medium, and system for image processing are described. One or more aspects of the method, apparatus, non-transitory computer readable medium, and system include obtaining an image and a style guide, wherein the image depicts an object with a first color and the style guide includes a second color; generating a first color embedding and a second color embedding based on the first color and the second color, respectively; selecting the second color from the style guide by comparing the first color embedding of the first color and the second color embedding of the second color; and generating a modified image based on the image and the second color, wherein the modified image depicts the object with the second color.

Some examples of the method, apparatus, non-transitory computer readable medium, and system further include generating a first text description of the first color in the image, wherein the first color embedding is generated based on the first text description. Some examples further include generating a second text description of the second color in the style guide, wherein the second color embedding is generated based on the second text description.

Some examples of the method, apparatus, non-transitory computer readable medium, and system further include providing a style transformation element in a user interface. Some examples further include receiving a single click input via the style transformation element, wherein the modified image is generated based on the single click input. Some examples of the method, apparatus, non-transitory computer readable medium, and system further include identifying a color application parameter, wherein the second color is selected based on the color application parameter. In some examples, the style guide comprises a font, a text color, a background color, a logo, or any combination thereof.

Some examples of the method, apparatus, non-transitory computer readable medium, and system further include obtaining a document including the image. Some examples further include generating a modified document including the modified image. Some examples of the method, apparatus, non-transitory computer readable medium, and system further include receiving a page selection input.

Some examples further include applying the style guide to a plurality of pages of the document based on the page selection input. Some examples of the method, apparatus, non-transitory computer readable medium, and system further include applying a first style attribute of the style guide to a first element of the document. Some examples further include applying a second style attribute of the style guide to a second element of the document.

Some examples of the method, apparatus, non-transitory computer readable medium, and system further include applying a font from the style guide to a text element of the document. Some examples of the method, apparatus, non-transitory computer readable medium, and system further include obtaining a video including a plurality of frames, wherein the image comprises a frame of the plurality of frames of the video. Some examples further include applying the style guide to the plurality of frames of the video.

### Network Architecture

FIG. 13 shows an example of an image processing apparatus according to aspects of the present disclosure. The example shown includes document processing apparatus 1300, processor unit 1305, I/O module 1310, memory unit 1315, document processing model 1320, and training component 1345. Document processing apparatus 1300 is an example of, or includes aspects of, the corresponding element described with reference to FIG. 1.

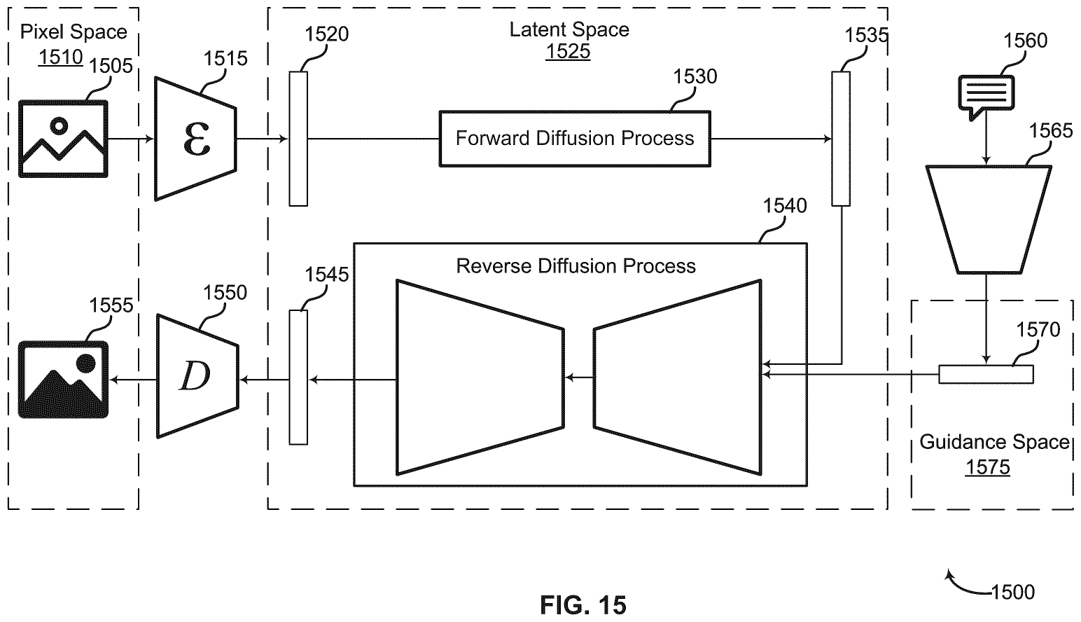

Document processing apparatus 1300 may include an example of, or aspects of, the guided diffusion model described with reference to FIG. 15. In some embodiments, document processing apparatus 1300 includes processor unit 1305, I/O module 1310, user interface 1325, memory unit 1315, document processing model 1320, and training component 1245. Training component 1345 updates parameters of the language generation model 1335 stored in memory unit 1315. In some examples, the training component 1345 is located outside the document processing apparatus 1300.

Processor unit 1305 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1305 is configured to operate a memory array using a memory controller. In other cases, a memory controller is integrated into processor unit 1305. In some cases, processor unit 1305 is configured to execute computer-readable instructions stored in memory unit 1315 to perform various functions. In some aspects, processor unit 1305 includes special-purpose components for modem processing, baseband processing, digital signal processing, or transmission processing. According to some aspects, processor unit 1305 comprises one or more processors described with reference to FIG. 31.

Memory unit 1315 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1305 to perform various functions described herein.

In some cases, memory unit 1315 includes a basic input/output system (BIOS) that controls basic hardware or software operations, such as an interaction with peripheral components or devices. In some cases, memory unit 1315 includes a memory controller that operates memory cells of memory unit 1315. For example, the memory controller may include a row decoder, column decoder, or both. In some cases, memory cells within memory unit 1315 store information in the form of a logical state. According to some aspects, memory unit 1315 is an example of the memory subsystem 3110 described with reference to FIG. 31.

According to some aspects, document processing apparatus 1300 uses one or more processors of processor unit 1305 to execute instructions stored in memory unit 1315 to perform functions described herein. For example, document processing apparatus 1300 may obtain an image and a style guide, where the image depicts an object with a first color and the style guide includes a second color. Document processing apparatus 1300 generates a first color embedding and a second color embedding based on the first color and the second color, respectively. Document processing apparatus 1300 selects the second color from the style guide by comparing the first color embedding of the first color and the second color embedding of the second color. Document processing apparatus 1300 generates a modified image based on the image and the second color, wherein the modified image depicts the object with the second color.

In some embodiments, the document processing model 1320 is an artificial neural network (ANN) such as the guided diffusion model described with reference to FIG. 15. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of document processing model 1320 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1345 may train the document processing model 1320. For example, parameters of the document processing model 1320 can be learned or estimated from training data and then used to make predictions or perform tasks based on learned patterns and relationships in the data. In some examples, the parameters are adjusted during the training process to minimize a loss function or maximize a performance metric (e.g., as described with reference to FIG. 30). The goal of the training process may be to find optimal values for the parameters that allow the machine learning model to make accurate predictions or perform well on the given task.

Accordingly, the node weights can be adjusted to increase the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the document processing model 1320 can be used to make predictions on new, unseen data (i.e., during inference).

I/O module 1310 receives inputs from and transmits outputs of the document processing apparatus 1300 to other devices or users. For example, I/O module 1310 receives inputs for the document processing model 1320 and transmits outputs of the document processing model 1320. According to some aspects, I/O module 1310 is an example of the I/O interface 3120 described with reference to FIG. 31.

According to some embodiments, document processing model 1320 obtains a document including the image. In some examples, document processing model 1320 generates a modified document including the modified image. In some examples, document processing model 1320 obtains a video including a set of frames, where the image includes a frame of the set of frames of the video.

According to some embodiments, document processing model 1320 generates a modified document that includes the modified image and the modified text element. In one aspect, document processing model 1320 includes user interface 1325, style guide engine 1330, language generation model 1335, and image generation model 1340.

User interface 1325 is an example of, or includes aspects of, the corresponding element described with reference to FIGS. 3-11, 18, 19, and 26-29.

In some examples, the style guide includes a font, a text color, a background color, a logo, or any combination thereof. In some examples, style guide engine 1330 applies the style guide to a set of pages of the document based on the page selection input. In some examples, style guide engine 1330 applies a first style attribute of the style guide to a first element of the document. In some examples, style guide engine 1330 applies a second style attribute of the style guide to a second element of the document. In some examples, style guide engine 1330 applies a font from the style guide to a text element of the document. In some examples, style guide engine 1330 applies the style guide to the set of frames of the video.

According to some embodiments, style guide engine 1330 applies the font from the style guide to the text element to obtain a modified text element. In some examples, style guide engine 1330 applies the second color from the style guide to the image to obtain a modified image, where the modified image depicts the object with the second color. In some examples, style guide engine 1330 applies an additional font, which is different from the font, from the style guide to an additional text element of the document to obtain an additional modified text element, where the modified document includes the additional modified text element. In some examples, style guide engine 1330 applies the style guide to a set of pages of the document based on the page selection input. In some examples, style guide engine 1330 applies a first style attribute of the style guide to a first element of the document. In some examples, style guide engine 1330 applies a second style attribute of the style guide to a second element of the document.

According to some embodiments, language generation model 1335 generates a first color embedding and a second color embedding based on the first color and the second color, respectively. In some examples, language generation model 1335 selects the second color from the style guide by comparing the first color embedding of the first color and the second color embedding of the second color. In some examples, language generation model 1335 generates a first text description of the first color in the image, where the first color embedding is generated based on the first text description. In some examples, language generation model 1335 generates a second text description of the second color in the style guide, where the second color embedding is generated based on the second text description.

According to some embodiments, language generation model 1335 generates a first text description of the first color in the image. In some examples, language generation model 1335 generates a first color embedding based on the first text description. In some examples, language generation model 1335 generates a second text description of the second color in the style guide. In some examples, language generation model 1335 generates a second color embedding based on the second text description.

According to some embodiments, language generation model 1335 generates a first color embedding and a second color embedding based on the first color and the second color, respectively. In some examples, language generation model 1335 selects the second color from the style guide by comparing the first color embedding of the first color and the second color embedding of the second color.

According to some embodiments, image generation model 1340 generates a modified image based on the image and the second color, where the modified image depicts the object with the second color.

According to some embodiments, image generation model 1340 generates a modified image based on the image and the second color, where the modified image depicts the object with the second color. In some examples, image generation model 1340 generates the modified image by applying the second color to the object.

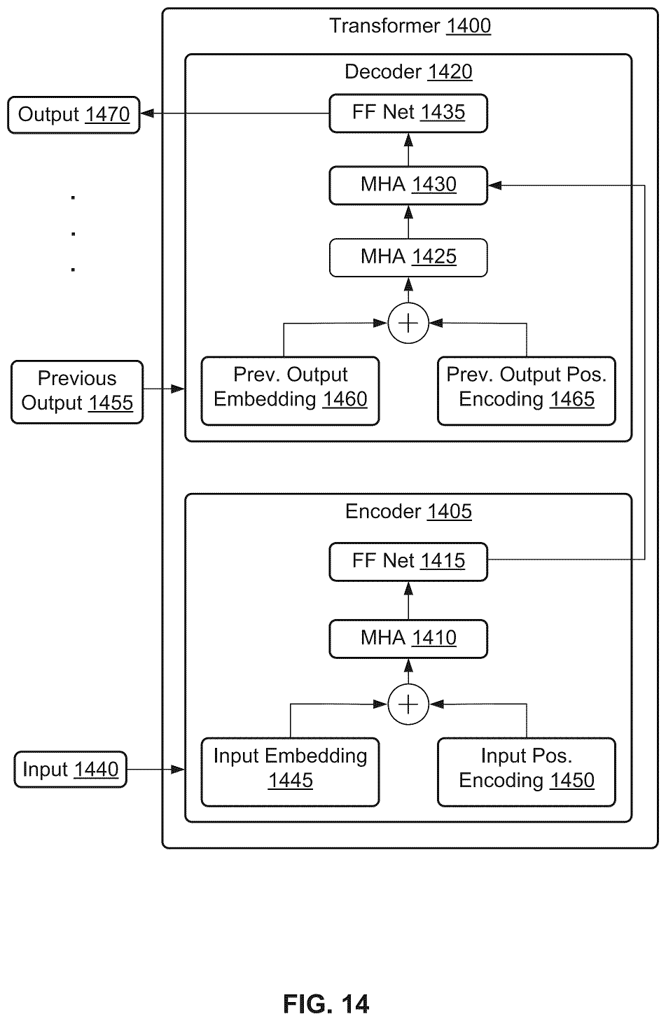

FIG. 14 shows an example of a transformer network according to aspects of the present disclosure. The example shown includes transformer 1400, encoder 1405, decoder 1420, input 1440, input embedding 1445, input positional encoding 1450, previous output 1455, previous output embedding 1460, previous output positional encoding 1465, and output 1470.

In some cases, encoder 1405 includes multi-head self-attention sublayer 1410 and feed-forward network sublayer 1415. In some cases, decoder 1420 includes first multi-head self-attention sublayer 1425, second multi-head self-attention sublayer 1430, and feed-forward network sublayer 1435.

According to some aspects, a machine learning model (such as the machine learning model described with reference to FIG. 13) comprises transformer 1400. In some cases, encoder 1405 is configured to map input 1440 (for example, a query or a prompt comprising a sequence of words or tokens) to a sequence of continuous representations that are fed into decoder 1420. In some cases, decoder 1420 generates output 1470 (e.g., a prediction of an output sequence of words or tokens) based on the output of encoder 1405 and previous output 1455 (e.g., a previously predicted output sequence), which allows for the use of autoregression.

For example, in some cases, encoder 1405 parses input 1440 into tokens and vectorizes the parsed tokens to obtain input embedding 1445, and adds input positional encoding 1450 (e.g., positional encoding vectors for input 1440 of a same dimension as input embedding 1445) to input embedding 1445. In some cases, input positional encoding 1450 includes information about relative positions of words or tokens in input 1440.

In some cases, encoder 1405 comprises one or more encoding layers (e.g., six encoding layers) that generate contextualized token representations, where each representation corresponds to a token that combines information from other input tokens via self-attention mechanism. In some cases, each encoding layer of encoder 1405 comprises a multi-head self-attention sublayer (e.g., multi-head self-attention sublayer 1410). In some cases, the multi-head self-attention sublayer implements a multi-head self-attention mechanism that receives different linearly projected versions of queries, keys, and values to produce outputs in parallel. In some cases, each encoding layer of encoder 1405 also includes a fully connected feed-forward network sublayer (e.g., feed-forward network sublayer 1415) comprising two linear transformations surrounding a Rectified Linear Unit (ReLU) activation:

$$FFN ( x ) = ReLU ( {W}_{1} x + {b}_{1} ) {W}_{2} + {b}_{2} \qquad ( 1 )$$

In some cases, each layer employs different weight parameters (W₁, W₂) and different bias parameters (b₁, b₂) to apply a same linear transformation each word or token in input 1440.

In some cases, each sublayer of encoder 1405 is followed by a normalization layer that normalizes a sum computed between a sublayer input x and an output sublayer (x) generated by the sublayer:

$$layernorm ( x + sublayer ( x ) ) \qquad ( 2 )$$

In some cases, encoder 1405 is bidirectional because encoder 1405 attends to each word or token in input 1440 regardless of a position of the word or token in input 1440.

In some cases, decoder 1420 comprises one or more decoding layers (e.g., six decoding layers). In some cases, each decoding layer comprises three sublayers including a first multi-head self-attention sublayer (e.g., first multi-head self-attention sublayer 1425), a second multi-head self-attention sublayer (e.g., second multi-head self-attention sublayer 1430), and a feed-forward network sublayer (e.g., feed-forward network sublayer 1435). In some cases, each sublayer of decoder 1420 is followed by a normalization layer that normalizes a sum computed between a sublayer input x and an output sublayer (x) generated by the sublayer.

In some cases, decoder 1420 generates previous output embedding 1460 of previous output 1455 and adds previous output positional encoding 1465 (e.g., position information for words or tokens in previous output 1455) to previous output embedding 1460. In some cases, each first multi-head self-attention sublayer receives the combination of previous output embedding 1460 and previous output positional encoding 1465 and applies a multi-head self-attention mechanism to the combination. In some cases, for each word in an input sequence, each first multi-head self-attention sublayer of decoder 1420 attends only to words preceding the word in the sequence, and so transformer 1400's prediction for a word at a particular position only depends on known outputs for a word that came before the word in the sequence. For example, in some cases, each first multi-head self-attention sublayer implements multiple single-attention functions in parallel by introducing a mask over values produced by the scaled multiplication of matrices Q and K by suppressing matrix values that would otherwise correspond to disallowed connections.

In some cases, each second multi-head self-attention sublayer implements a multi-head self-attention mechanism similar to the multi-head self-attention mechanism implemented in each multi-head self-attention sublayer of encoder 1405 by receiving a query Q from a previous sublayer of decoder 1420 and a key K and a value V from the output of encoder 1405, allowing decoder 1420 to attend to each word in the input 1440.

In some cases, each feed-forward network sublayer implements a fully connected feed-forward network similar to feed-forward network sublayer 1415. In some cases, the feed-forward network sublayers are followed by a linear transformation and a softmax function to generate a prediction of output 1470 (e.g., a prediction of a next word or token in a sequence of words or tokens). Accordingly, in some cases, transformer 1400 generates a response as described herein based on a predicted sequence of words or tokens.

FIG. 15 shows an example of a guided diffusion model according to aspects of the present disclosure. The guided latent diffusion model 1500 depicted in FIG. 15 is an example of, or includes aspects of, the corresponding element (i.e., language generation model 1335) described with reference to FIG. 13.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 1500 may take an original image 1505 in a pixel space 1510 as input and apply and image encoder 1515 to convert original image 1505 into original image features 1520 in a latent space 1525. Then, a forward diffusion process 1730 gradually adds noise to the original image features 1520 to obtain noisy features 1535 (also in latent space 1525) at various noise levels.

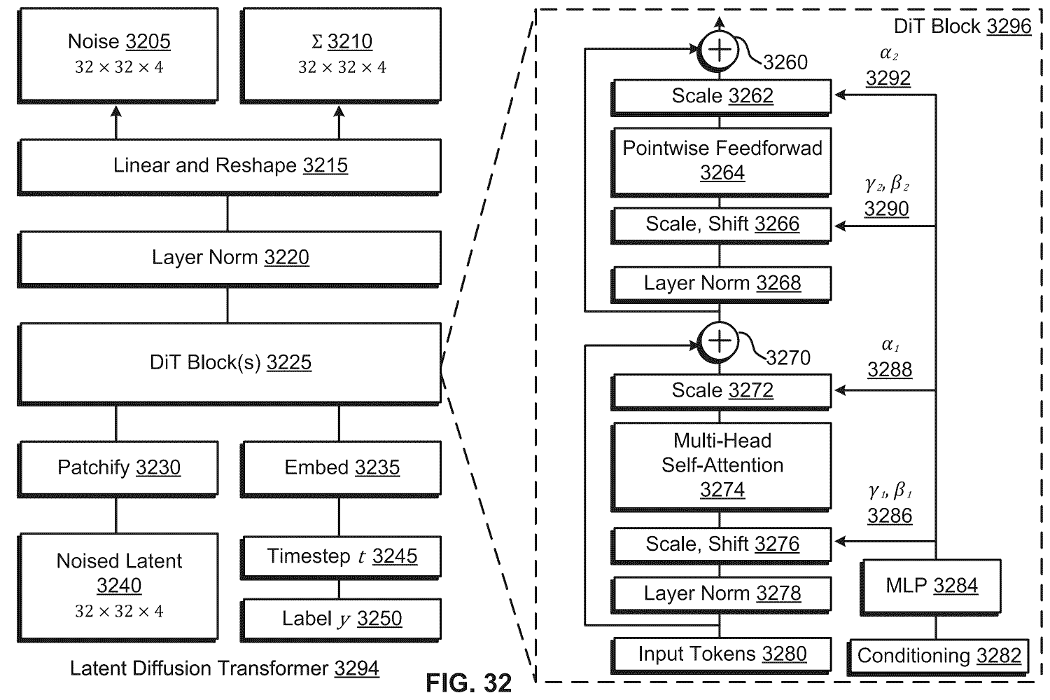

Next, a reverse diffusion process 1540 (e.g., a U-Net ANN, a DiT architecture described in FIG. 32) gradually removes the noise from the noisy features 1535 at the various noise levels to obtain denoised image features 1545 in latent space 1525. In some examples, the denoised image features 1545 are compared to the original image features 1520 at each of the various noise levels, and parameters of the reverse diffusion process 1540 of the diffusion model are updated based on the comparison. Finally, an image decoder 1550 decodes the denoised image features 1545 to obtain an output image 1555 in pixel space 1510. In some cases, an output image 1555 is created at each of the various noise levels. The output image 1555 can be compared to the original image 1505 to train the reverse diffusion process 1540.

In some cases, image encoder 1515 and image decoder 1550 are pre-trained prior to training the reverse diffusion process 1540. In some examples, image encoder 1515 and image decoder 1550 are trained jointly, or the image encoder 1515 and image decoder 1550 and fine-tuned jointly with the reverse diffusion process 1540.

The reverse diffusion process 1540 can also be guided based on a text prompt 1560, or another guidance prompt, such as an image, a layout, a segmentation map, etc. The text prompt 1560 can be encoded using a text encoder 1565 (e.g., a multimodal encoder) to obtain guidance features 1570 in guidance space 1575. The guidance features 1570 can be combined with the noisy features 1535 at one or more layers of the reverse diffusion process 1540 to ensure that the output image 1555 includes content described by the text prompt 1560. For example, guidance features 1570 can be combined with the noisy features 1535 using a cross-attention block within the reverse diffusion process 1540.

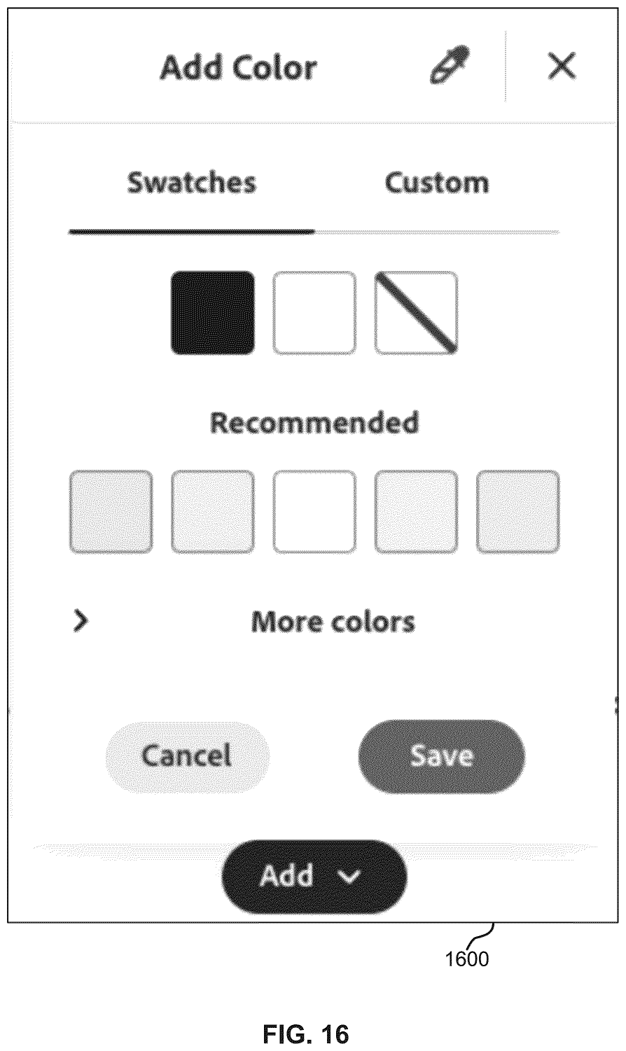

FIG. 16 shows an example of a color application interface 1600 according to aspects of the present disclosure. FIG. 16 shows that users can add or remove candidate colors with regard to a style guide. In some examples, a style guide includes one or more fonts, one or more text colors, one or more background colors, one or more image color, one or more images, or any combination thereof. The style guide includes the color palette. The color palette is applied to pages of a document to obtain a modified document. In some cases, a user chooses a set of candidate colors to form a color palette as a part of the style guide.

In an example shown in FIG. 16, a user edits a color palette and related settings via color application interface 1600. The color application interface 1600 is a graphic user interface including a dialog box labeled “Add Color”. The color application interface 1600 includes “Swatches” tab and “Custom” tab, each referring to a color selection method. For example, the “Swatches” tab shows predefined color options and a “Recommended” section (recommended colors). The “Custom” tab enables personalized color selection. The color application interface 1600 includes a color canvas selection tool that selects colors from a canvas (i.e., access to a wide range of colors). Users manage the color selection process via “Cancel” button and “Save” button.

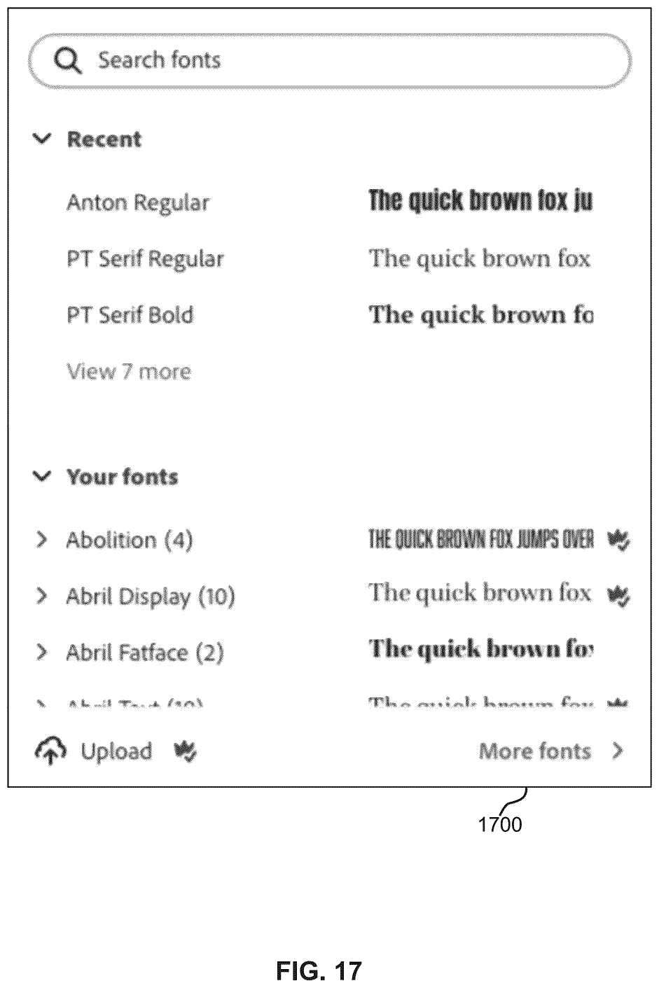

FIG. 17 shows an example of a font application interface 1700 according to aspects of the present disclosure. The font application interface 1700 is a graphic user interface including a dialog box with a search bar. The search bar on the top of the font application interface 1700 is used to find one or more fonts. The font application interface 1700 includes a first section labeled “Recent” and a second section labeled “Your fonts”. The first section displays recently used fonts. The second section displays user-specified fonts. For example, the “Recent” section includes fonts such as Anton Regular and PT Serif Regular, etc. Users may click on “view more” to view additional fonts. The “Your fonts” section categorizes fonts, for example, Abolition and Abril Display. The font application interface 1700 provides a font preview of each font for text “The quick brown fox”. The font application interface 1700 includes interactive elements for uploading additional font(s) and accessing a wide selection of fonts via clicking on “More fonts” button. Therefore, efficiency in font selection and customization is increased.

FIG. 18 shows an example of style transformation element 1805 and style guide setting according to aspects of the present disclosure. The example shown includes user interface 1800, style transformation element 1805, and style guide setting element 1810. User interface 1800 is an example of, or includes aspects of, the corresponding element described with reference to FIGS. 3-11, 13, 19, and 26-29.

FIG. 18 shows a zoom-in view of control panel on the left-hand region of user interface 1800. In some examples, “recolor graphics” setting is for a single page of a document. The “recolor graphics” setting may be turned off (or disabled) for a document including multiple pages. In one embodiment, style guide setting element 1810 includes page application element 1815, color application parameter 1820, font application parameter 1825, and image recolor parameter 1830.

In an example shown in FIG. 18, a style guide application tool in user interface 1800 is used to apply a style guide (e.g., a brand or a collection of brand related assets) to multiple pages of a document. The available settings include “apply colors”, “apply fonts”, and “apply to all pages”. In contrast to FIG. 19, “apply to all pages” selection parameter of the style guide application tool is turned on (or enabled) because the document includes multiple pages. In some examples, apply to all pages setting applies the colors and fonts to all pages of the document (e.g., a presentation, an Instagram® story). The style guide application tool in user interface 1800 ensures that the colors and fonts are applied the same way across the multiple pages of the document. For example, if a presentation has multiple pages which have red in background and green in the foreground, the brand colors across multiple pages would be replaced in the same fashion (e.g., brand blue background, brand maroon foreground).

Style transformation element 1805 is an example of, or includes aspects of, the corresponding element described with reference to FIGS. 3, 4, 6-11, 19, 26, and 27. Style guide setting element 1810 is an example of, or includes aspects of, the corresponding element described with reference to FIGS. 3 and 19. Page application element 1815 is an example of, or includes aspects of, the corresponding element described with reference to FIG. 19. Color application parameter 1820 is an example of, or includes aspects of, the corresponding element described with reference to FIG. 19. Font application parameter 1825 is an example of, or includes aspects of, the corresponding element described with reference to FIG. 19. Image recolor parameter 1830 is an example of, or includes aspects of, the corresponding element described with reference to FIG. 19.

FIG. 19 shows an example of a user interface 1900 according to aspects of the present disclosure. The example shown includes user interface 1900, style transformation element 1905, and style guide setting element 1910. User interface 1900 is an example of, or includes aspects of, the corresponding element described with reference to FIGS. 3-11, 13, 18, and 26-29.

In one embodiment, style guide setting element 1910 includes page application element 1915, color application parameter 1920, font application parameter 1925, and image recolor parameter 1930.

In an example shown in FIG. 19, user interface 1900 displays user-selectable fields or style guide settings. In some cases, the style guide settings are also referred to as brand settings. To apply a style guide to a page of a document, users can click on a style guide application tool located in user interface 1900. The available style guide settings include “apply colors”, “apply fonts”, and “recolor graphics”. In this example, “apply to all pages” selection parameter of the style guide application tool is turned off (or disabled) because the document includes a single page.

Style transformation element 1905 is an example of, or includes aspects of, the corresponding element described with reference to FIGS. 3, 4, 6-11, 18, 26, and 27. Style guide setting element 1910 is an example of, or includes aspects of, the corresponding element described with reference to FIGS. 3 and 18. Page application element 1915 is an example of, or includes aspects of, the corresponding element described with reference to FIG. 18. Color application parameter 1920 is an example of, or includes aspects of, the corresponding element described with reference to FIG. 18. Font application parameter 1925 is an example of, or includes aspects of, the corresponding element described with reference to FIG. 18. Image recolor parameter 1930 is an example of, or includes aspects of, the corresponding element described with reference to FIG. 18.

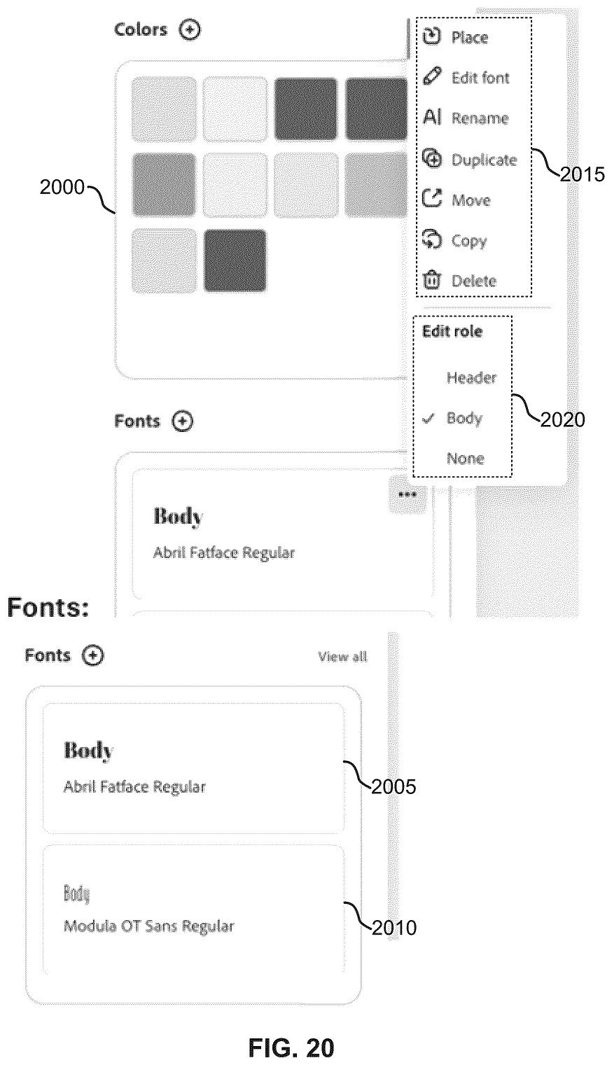

FIG. 20 shows an example of a style guide according to aspects of the present disclosure. The example shown includes candidate colors 2000, first font 2005, second font 2010, font editing tools 2015, and font role parameters 2020.

FIG. 20 shows an example of login and memory function (e.g., saved colors, saved fonts). Any number of colors can be added to a style guide (e.g., a collection of brand related assets), but companies usually have 5 to 8 colors at maximum in their brand targeting a marketing campaign. The brand colors are used for all of the digital media consistently to ensure their customers get a clear portrayal of the company's brand. For example, a company uses green and white everywhere while another company uses red everywhere in their stores. Everything from their digital application to websites to printed brochures and media uses the same brand related color scheme. In an example of FIG. 20, the colors are associated with a brand for a mountain apparel company.

A font is assigned a role of Header, Body or None. A style guide includes multiple fonts. By a single click on “Apply brand”, the document processing model 1320 as described with reference to FIG. 13 applies a combination of three types of fonts (e.g., Header, Body and None) selected from the style guide associated with a brand.

Additionally or alternatively, a style guide includes digital assets such as logos, templates, digital images, etc. These brand related assets may be re-used across page(s) of a target document. These assets are optional for the “Apply brand” feature implemented in the user interface.

Candidate colors 2000 is an example of, or includes aspects of, the corresponding element described with reference to FIGS. 3, 4, and 7-11. First font 2005 is an example of, or includes aspects of, the corresponding element described with reference to FIGS. 5, 6, 26, and 27. Second font 2010 is an example of, or includes aspects of, the corresponding element described with reference to FIGS. 5, 6, 26, and 27.

In FIGS. 13-20, an apparatus, system, and method for image processing are described. One or more aspects of the apparatus, system, and method include a memory component; a processing device coupled to the memory component, the processing device configured to perform operations comprising: obtaining an image and a style guide, wherein the image depicts an object with a first color and the style guide includes a second color; generating a first color embedding and a second color embedding based on the first color and the second color, respectively; selecting the second color from the style guide by comparing the first color embedding of the first color and the second color embedding of the second color; and generating a modified image based on the image and the second color, wherein the modified image depicts the object with the second color.

Some examples of the apparatus, system, and method further include a language generation model configured to generate the first color embedding and the second color embedding. Some examples of the apparatus, system, and method further include an image generation model configured to generate the modified image by applying the second color to the object.

Some examples of the apparatus, system, and method further include providing a style transformation element in a user interface. Some examples further include receiving a single click input via the style transformation element, wherein the modified image is generated based on the single click input.

### Style Guide Application

FIG. 21 shows an example of a method 2100 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

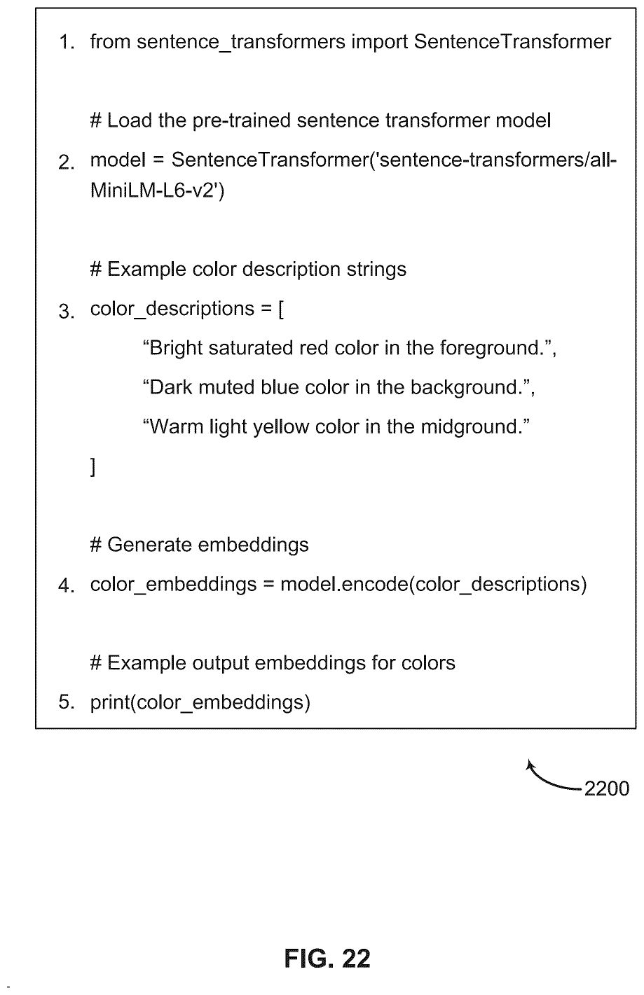

At operation 2105, the system generates a first text description of the first color in the image. For example, the first text description of the first color is “Bright saturated red color in the foreground”. The first text description is also referred to as a color description (textual) string. More examples of text description of a color are described with reference to FIG. 22. In some cases, the operations of this step refer to, or may be performed by, a language generation model as described with reference to FIG. 13.

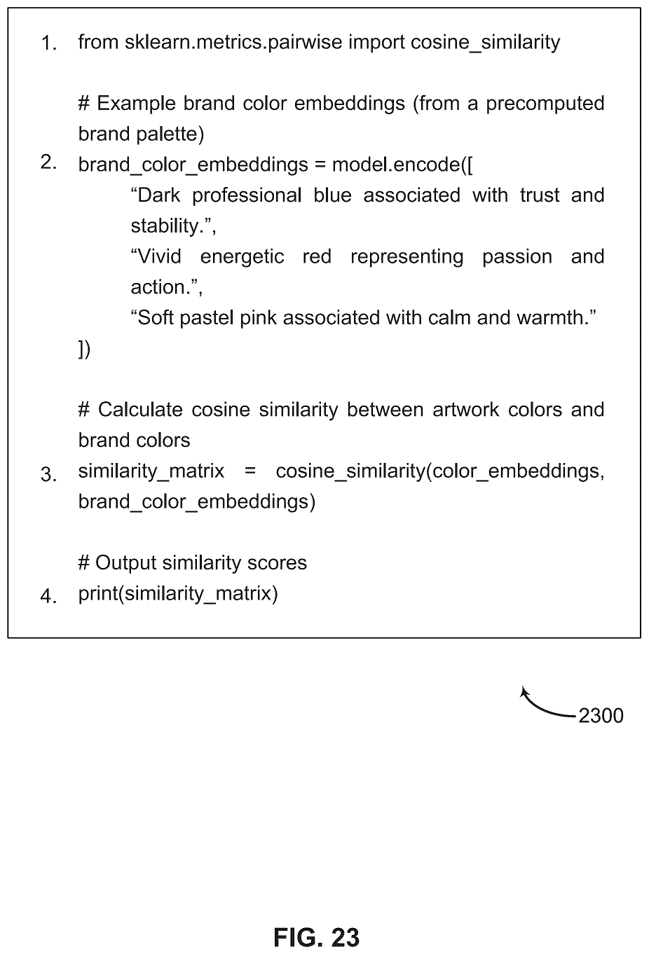

At operation 2110, the system generates a first color embedding based on the first text description. In some examples, the first color embedding is a representation of the first color in a vector space. In some cases, the operations of this step refer to, or may be performed by, a language generation model as described with reference to FIG. 13. The process of generating a color embedding is described with reference to FIGS. 22-23.

At operation 2115, the system generates a second text description of the second color in the style guide. For example, the second text description of the second color is “Dark professional blue associated with trust and stability”. The second color comes from a precomputed brand palette. More examples of brand color description are described with reference to FIG. 23. In some cases, the operations of this step refer to, or may be performed by, a language generation model as described with reference to FIG. 13.

At operation 2120, the system generates a second color embedding based on the second text description. In some examples, the second color embedding is a representation of the second color in a vector space. The second color embedding may be referred to as a brand color embedding. In some cases, the operations of this step refer to, or may be performed by, a language generation model as described with reference to FIG. 13. The process of generating a brand color embedding is described with reference to FIGS. 22-23.

FIG. 22 shows an example of an algorithm 2200 of using a sentence transformer according to aspects of the present disclosure.

In some embodiments, a color matching network (also known as language generation model 1335 as described with reference to FIG. 13) is trained to understand the meaning and context of both the ECS artwork and brand guidelines and provides intelligent color suggestions. The color matching network balances artistic freedom with brand consistency, making more fluid adjustments rather than rigid transformations.

In some examples, the color matching network uses text-based embeddings to improve how colors are understood, represented, and matched. Instead of using traditional one-hot encoding or direct numeric representations/clustering of colors (e.g., RGB), the color matching network treats colors as semantic concepts and uses LLM-based embeddings to capture the relationships between them. By creating a textual representation of the color data and using an LLM (e.g., sentence-transformers library by Huggingface) to generate embeddings, embodiments of the present disclosure can enhance the brand matching process with deeper context and understanding of color relationships.

In an embodiment, the color matching network treats colors as descriptive features by converting color information into text (instead of treating each color as an isolated data point). The text strings describe not only the raw color values but also attributes like brightness, tone, emotional context, and spatial hierarchy. The color matching network generates a text string that describes each entity's color information along with other relevant properties. The text string is fed to a pre-trained LLM to generate a high-dimensional embedding that captures the relationships between colors. For example (with regard to a color descriptor string), assume an entity in the ECS has an RGB color of (255, 0, 0) and is on the foreground (Layer 2) with high brightness and saturation. The color matching network can describe this entity as “Bright saturated red color in the foreground”. The sentence may include (1) the color name or description (e.g., “red,” “dark blue”); (2) brightness and saturation descriptions (e.g., “bright”, “muted”); (3) location/layer in the visual hierarchy (e.g., “foreground”, “background”); and (4) emotional tone or inferred sentiment (e.g., “warm”, “calm”).

The color matching network generates a dense vector representation (embedding) for each color that captures more than just the raw RGB values. The color matching network captures the relationships and context between the colors, as well as how they fit into the visual and emotional hierarchy of the artwork.

FIG. 23 shows an example of an algorithm 2300 of computing a similarity score for color matching according to aspects of the present disclosure. The similarity score can be used to determine a proximity criterion for selecting a color from a style guide. For example, the proximity criterion can include determining that a color is below a threshold similarity score, or it can be determined by maximizing the similarity score or minimizing a cosine distance.

The color matching network uses the color embeddings generated from LLM to create a more nuanced and contextual brand matching process. Instead of simply matching raw RGB values to brand colors, the color matching network compares the semantic embeddings of extracted artwork colors to the embeddings of brand colors, allowing for flexible, context-aware matching. First, the color matching network generates brand palette representation by converting each brand color into a text string that describes not just the color but also the brand's tone and identity associated with it.

For example (brand color descriptor), for a brand color of dark blue, the color matching network generates “Dark professional blue associated with trust and stability”. Next, the color matching network performs embedding comparison, i.e., using the embeddings for both the extracted artwork colors and the brand colors, the color matching network calculates the cosine similarity between embeddings to determine how close a given artwork color is to a brand color (not just in RGB space, but in semantic space).

Through computing cosine similarity for color matching, the color matching network computes a similarity score between every artwork color and every brand color, which is used to find the closest match or suggest slight adjustments to bring the artwork closer to the brand's color identity.

In some examples, since one can adjust brand color attributes, the color matching network can generate variations of brand color descriptors by tweaking attributes like brightness, saturation, or context to see if they yield higher similarity scores. The color matching network generates embeddings for these variations and includes them in the matching process.

In some examples, for each artwork color, the color matching network sorts the brand colors (or their variations) based on the similarity scores from highest to lowest. The color matching network provides a ranked list of potential matches, allowing users to select the best one or consider alternative groupings.

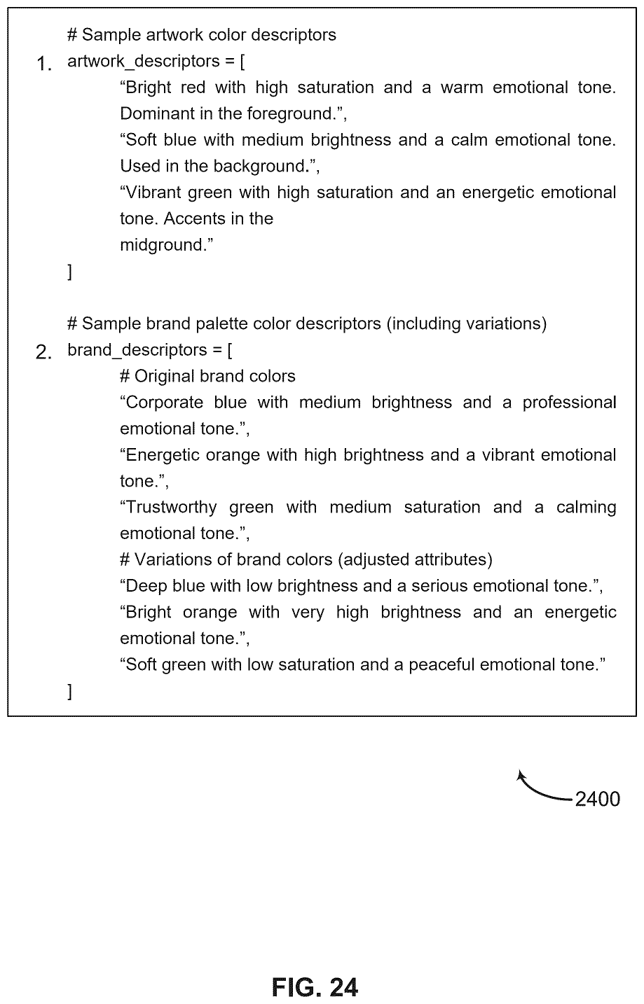

FIG. 24 shows an example of text description of a color according to aspects of the present disclosure. In some examples, text descriptions 2400 are sample inputs to a language generation model as described with reference to FIG. 13. FIG. 24 is an example of a proximity criterion for selecting a color from a style guide.

TABLE 1
Sample Output.

Artwork Color Descriptor: Bright red with high saturation and a warm
emotional tone. Dominant in the foreground.
Top Matches:
Match 1: Brand Color Descriptor: Bright orange with very high brightness
and an energetic emotional tone.
Similarity Score: 0.9021
Match 2: Brand Color Descriptor: Energetic orange with high brightness
and a vibrant emotional tone.
Similarity Score: 0.8765
Match 3:
Brand Color Descriptor: Deep blue with low brightness and a serious
emotional tone.
Similarity Score: 0.6543

TABLE 2
Sample Output.

Artwork Color Descriptor: Soft blue with medium brightness and a calm
emotional tone. Used in the background.
Top Matches:
Match 1: Brand Color Descriptor: Corporate blue with medium brightness
and a professional emotional tone.
Similarity Score: 0.9123
Match 2: Brand Color Descriptor: Deep blue with low brightness and a
serious emotional tone.
Similarity Score: 0.8567
Match 3: Brand Color Descriptor: Soft green with low saturation and a
peaceful emotional tone.
Similarity Score: 0.7345

TABLE 3
Sample Output.

Artwork Color Descriptor: Vibrant green with high saturation and an
energetic emotional tone. Accents in the midground.
Top Matches:
Match 1: Brand Color Descriptor: Trustworthy green with medium
saturation and a calming emotional tone.
Similarity Score: 0.8789
Match 2: Brand Color Descriptor: Soft green with low saturation and a
peaceful emotional tone.
Similarity Score: 0.8123
Match 3: Brand Color Descriptor: Energetic orange with high brightness
and a vibrant emotional tone.
Similarity Score: 0.6987

In an embodiment, the color matching network maintains artistic essence by allowing colors to be adapted while keeping the artwork's visual essence intact. The color matching network provides context-awareness since colors are transformed based on their contextual role in the artwork (e.g., logo vs. background). The color matching network generates flexible and consistent results. The color matching network ensures brand consistency while providing enough flexibility for non-critical elements, balancing strictness and creative freedom.

By treating color transformation similar to sentence transformation, embodiments of the present disclosure provide a sophisticated and flexible system for matching brand colors in artwork. The color matching network can preserve the meaning or essence of the original colors (just as sentence transformations preserve meaning in text). Through color vector encoding, context-aware transformations, and adaptive flexibility, the color matching network improves upon rigid color matching systems.

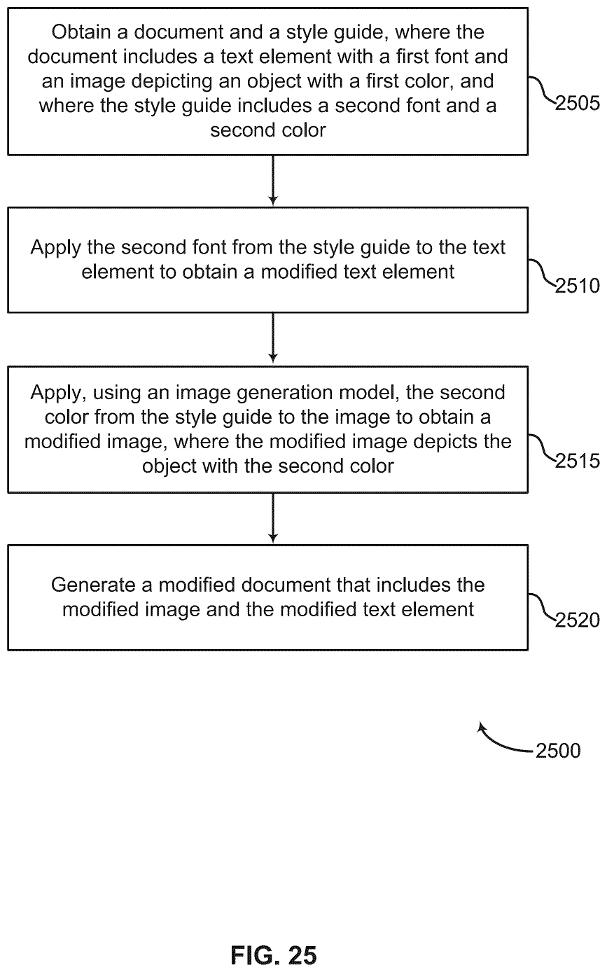

FIG. 25 shows an example of a method 2500 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 2505, the system obtains a document and a style guide, where the document includes a text element with a first font and an image depicting an object with a first color, and where the style guide includes a second font and a second color. An example of a document is document 705 described in FIG. 7. A text element is an example of, or includes aspects of, the corresponding element described with reference to FIGS. 5, 7, 26 and 28, e.g., first text element 525 in FIG. 5. An example of an image is described in FIG. 3, i.e., image 305. The style guide is an example of, or includes aspects of, the corresponding element described with reference to FIGS. 3-8, 10-11, 18-19, and 26-27. The second color is different from the first color. In some cases, the operations of this step refer to, or may be performed by, a user interface as described with reference to FIGS. 3-11, 13, 18-19 and 26-29.

At operation 2510, the system applies the second font from the style guide to the text element to obtain a modified text element. The modified text element is an example of, or includes aspects of, the corresponding element described with reference to FIGS. 6, 8, 27, and 29. An example of the modified text element is described in FIG. 6, i.e., first text element 625. In some cases, the operations of this step refer to, or may be performed by, a style guide engine as described with reference to FIG. 13.

At operation 2515, the system applies, using an image generation model, the second color from the style guide to the image to obtain a modified image, where the modified image depicts the object with the second color. The modified image is an example of, or includes aspects of, the corresponding element described with reference to FIGS. 4, 8, 27 and 29, e.g., modified image 405 in FIG. 4. In some cases, the operations of this step refer to, or may be performed by, a style guide engine as described with reference to FIG. 13.

At operation 2520, the system generates a modified document that includes the modified image and the modified text element. The modified document is an example of, or includes aspects of, the corresponding element described with reference to FIGS. 4, 6, 8, 27, and 29, e.g., modified document 805 in FIG. 8. In some cases, the operations of this step refer to, or may be performed by, a document processing model as described with reference to FIG. 13.

FIG. 26 shows an example of a style guide including font selection according to aspects of the present disclosure. The example shown includes user interface 2600, document 2605, style transformation element 2625, and candidate fonts 2630. User interface 2600 is an example of, or includes aspects of, the corresponding element described with reference to FIGS. 3-11, 13, 18, 19, and 27-29.

FIG. 26 shows a page of a document before applying font to the document via user interface 2600. In some examples, document 2605 includes first text element 2610, second text element 2615, and third text element 2620. Candidate fonts 2630 includes first font 2635, second font 2640, third font 2645, and fourth font 2650.

Document 2605 is an example of, or includes aspects of, the corresponding element described with reference to FIGS. 5, 7, and 10. First text element 2610 is an example of, or includes aspects of, the corresponding element described with reference to FIGS. 6 and 7. Second text element 2615 is an example of, or includes aspects of, the corresponding element described with reference to FIGS. 6 and 7. Third text element 2620 is an example of, or includes aspects of, the corresponding element described with reference to FIGS. 6 and 7.

Style transformation element 2625 is an example of, or includes aspects of, the corresponding element described with reference to FIGS. 3-4, 6-11, 18, 19, and 27. Candidate fonts 2630 is an example of, or includes aspects of, the corresponding element described with reference to FIGS. 3-4, and 27.

First font 2635 is an example of, or includes aspects of, the corresponding element described with reference to FIGS. 5-6, 20, and 27. Second font 2640 is an example of, or includes aspects of, the corresponding element described with reference to FIGS. 5-6, 20, and 27. Third font 2645 is an example of, or includes aspects of, the corresponding element described with reference to FIG. 27. Fourth font 2650 is an example of, or includes aspects of, the corresponding element described with reference to FIG. 27.

FIG. 27 shows an example of effect of applying a font according to aspects of the present disclosure. The example shown includes user interface 2700, modified document 2705, style transformation element 2725, and candidate fonts 2730. User interface 2700 is an example of, or includes aspects of, the corresponding element described with reference to FIGS. 3-11, 13, 18, 19, 26, 28, and 29.

In some examples, modified document 2705 includes first modified text element 2710, second modified text element 2715, and third modified text element 2720. Candidate fonts 2730 includes first font 2735, second font 2740, third font 2745, and fourth font 2750.

FIG. 27 shows a modified page of the document mentioned in FIG. 26 after applying font to the document via a single click on the “Apply brand” button in user interface 2700. The document processing model 1320 (as described with reference to FIG. 13) matches a font from style guide (located on the left-hand region of user interface 2700) to a corresponding text segment in the page of the document (i.e., size correspondence). In some examples, a first font 2735 that is marked as the header (i.e., header role font) in the style guide is applied to text (e.g., a text segment) with largest font in the page of the document. A second font 2740 with body role in the style guide is applied to text with the second largest font. A third font 2745 marked as “None” is applied to the remaining text in the page of the document). A style guide or a brand may include multiple fonts with the same role. For example, two header fonts and three body fonts are preselected by a user. The two header fonts include Header “Clean Black” and Header “Clean ExtraBold”. The three body fonts include Body “Clean Italic”, Body “Clean Bold”, and Body “Clean Regular”. The style guide (including the header fonts and the body fonts) are located on the left-hand region of user interface 2700. As a result, shuffling a style guide (or a brand), via a single click on the “Apply brand” button in user interface 2700, would apply different variations to generate different modified documents.

The document processing model 1320 obtains a selection parameter corresponding to a style attribute from the style guide, where the style attribute is applied to the document based on the selection parameter to obtain a modified document. In some examples, the document in FIG. 26 and the modified document in FIG. 27 each comprises a multi-media asset.

Modified document 2705 is an example of, or includes aspects of, the corresponding element described with reference to FIGS. 6, 8, 9, and 11. First modified text element 2710 is an example of, or includes aspects of, the corresponding element described with reference to FIGS. 8 and 9. Second modified text element 2715 is an example of, or includes aspects of, the corresponding element described with reference to FIGS. 8 and 9. Third modified text element 2720 is an example of, or includes aspects of, the corresponding element described with reference to FIGS. 8 and 9.

Style transformation element 2725 is an example of, or includes aspects of, the corresponding element described with reference to FIGS. 3, 4, 6-11, 18, 19, and 26. Candidate fonts 2730 is an example of, or includes aspects of, the corresponding element described with reference to FIGS. 3, 4, and 26.

First font 2735 is an example of, or includes aspects of, the corresponding element described with reference to FIGS. 5, 6, 20, and 26. Second font 2740 is an example of, or includes aspects of, the corresponding element described with reference to FIGS. 5, 6, 20, and 26. Third font 2745 is an example of, or includes aspects of, the corresponding element described with reference to FIG. 26. Fourth font 2750 is an example of, or includes aspects of, the corresponding element described with reference to FIG. 26.

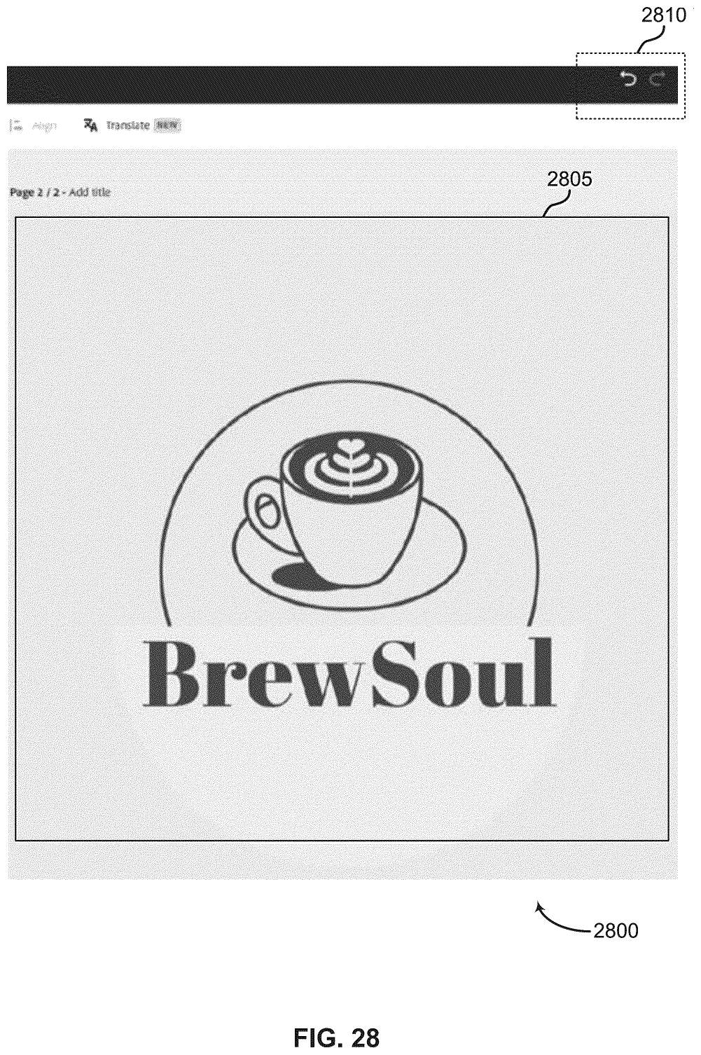

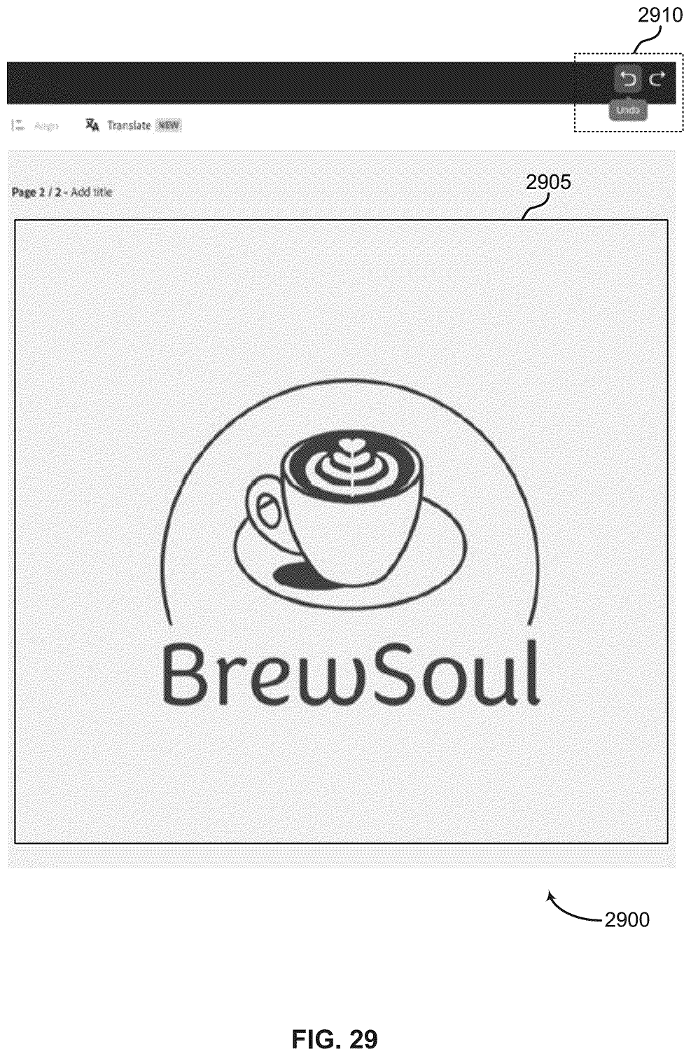

FIG. 28 shows an example of a state change effect according to aspects of the present disclosure. The example shown includes user interface 2800, first image 2805, and state change element 2810. User interface 2800 is an example of, or includes aspects of, the corresponding element described with reference to FIGS. 3-11, 13, 18, 19, 26, 27, and 29. State change element 2810 is an example of, or includes aspects of, the corresponding element described with reference to FIG. 29.

User interface 2800 includes undo button and redo button at the top right. Undo button and redo action in the canvas can undo or redo a style guide effect in a single click. In some cases, the document processing model 1320 described in FIG. 13 locks entities which users do not want changed by a brand application. Shuffling different variations of the brand is done by re-clicking the “Apply brand” button in user interface 2800.

The document (e.g., first image 2805) shown on user interface 2800 may represent a modified document after clicking on “Apply brand” button on user interface 2800. That is, the style guide is applied to an input document to obtain the modified document.

In some examples, user interface 2800 includes style guide application settings comprising logos, colors, and fonts, which are located on the left-hand region of user interface 2800. A style transformation element (e.g., “Apply brand” button) is located on the top-left region of user interface 2800 to receive a single click input from users.

In some examples, a user, via user interface 2800, implements style-specific elements (e.g., brand elements) across the document through one single click. In some cases, user interface 2800 displays a preview thumbnail of the modified document. As an example shown in FIG. 16, the modified document features a coffee cup with latte-style foam. The coffee cup is surrounded by circular line art. Text content (e.g., “BrewSoul”) is located next to in a bold font (e.g., bold serif font). The background color for the modified document is pink. The text content is inside a region having light blue color (e.g., light blue semicircle enclosing the “BrewSoul”).

FIG. 29 shows an example of a state change effect according to aspects of the present disclosure. The example shown includes user interface 2900, second image 2905, and state change element 2910. User interface 2900 is an example of, or includes aspects of, the corresponding element described with reference to FIGS. 3-11, 13, 18, 19, and 26-28. State change element 2910 is an example of, or includes aspects of, the corresponding element described with reference to FIG. 28.

As an example shown in FIG. 29, a user clicks “undo button” on the top right of user interface 2900. A document is displayed in user interface 2900 showing effect after “undo”. The undo button and the redo button are located at the top right region of user interface 2900.

User interface 2900 shows a document after clicking the “undo” button, i.e., the document includes style (e.g., fonts, background colors, graphics colors) and view before receiving a single click input to apply the style guide. By clicking on the undo button on top right of user interface 2900, the document processing model 1320 (as described in FIG. 13) can back out of the preceding style guide application and revert to a previous style of the document (e.g., an input document before applying the style guide).

In FIG. 29, the document features a logo with a stylized coffee cup with latte art, encircled by a partial outline. The text content “BrewSoul” has a rounded sans-serif font (bold serif font in FIG. 28). The document includes a beige background (pink background in FIG. 28). The light blue semicircle around “BrewSoul” is not here due to the undo action.

In FIGS. 21-29, a method, apparatus, non-transitory computer readable medium, and system for image processing are described. One or more aspects of the method, apparatus, non-transitory computer readable medium, and system include obtaining a document and a style guide, wherein the document includes a text element and an image depicting an object with a first color, and wherein the style guide includes a font and a second color; applying the font from the style guide to the text element to obtain a modified text element; applying the second color from the style guide to the image to obtain a modified image, wherein the modified image depicts the object with the second color; and generating a modified document that includes the modified image and the modified text element.

Some examples of the method, apparatus, non-transitory computer readable medium, and system further include generating a first text description of the first color in the image. Some examples further include generating a first color embedding based on the first text description. Some examples further include generating a second text description of the second color in the style guide. Some examples further include generating a second color embedding based on the second text description.

Some examples of the method, apparatus, non-transitory computer readable medium, and system further include providing a style transformation element in a user interface. Some examples further include receiving a single click input via the style transformation element, wherein the modified image is generated based on the single click input.

Some examples of the method, apparatus, non-transitory computer readable medium, and system further include applying an additional font, which is different from the font, from the style guide to an additional text element of the document to obtain an additional modified text element, wherein the modified document includes the additional modified text element.

Some examples of the method, apparatus, non-transitory computer readable medium, and system further include receiving a page selection input. Some examples further include applying the style guide to a plurality of pages of the document based on the page selection input.

Some examples of the method, apparatus, non-transitory computer readable medium, and system further include applying a first style attribute of the style guide to a first element of the document. Some examples further include applying a second style attribute of the style guide to a second element of the document.

FIG. 30 shows an example of a step-by-step procedure for training a machine learning model according to aspects of the present disclosure. FIG. 30 shows a flow diagram depicting an algorithm as a step-by-step procedure 3000 in an example implementation of operations performable for training a machine-learning model. In some embodiments, the procedure 3000 describes an operation of the training component 1345 described for configuring the document processing model 1320 as described with reference to FIG. 13. The procedure 3000 provides one or more examples of generating training data, use of the training data to train a machine learning model, and use of the trained machine learning model to perform a task.

To begin in this example, a machine-learning system collects training data (block 3002) to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 3004) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

To train the machine-learning model in the illustrated example, the machine-learning model is first initialized (block 3006). Initialization of the machine-learning model includes selecting a model architecture (block 3008) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 3010). The loss function is utilized to measure a difference between an output of the machine-learning model (i.e., predictions) and target values (e.g., as expressed by the training data) to be used to train the machine-learning model. Additionally, an optimization algorithm is selected (3012) to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 3014) examples of which includes initializing weights and biases of nodes to increase efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 3018) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 3020), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 3020), the procedure 3000 continues training of the machine-learning model using the training data (block 3018) in this example.

If the stopping criterion is met (“yes” from decision block 3020), the trained machine-learning model is then utilized to generate an output based on subsequent data (block 3022). The trained machine-learning model, for instance, is trained to perform a task as described above and therefore, once trained is configured to perform that task based on subsequent data received as an input and processed by the machine-learning model.

FIG. 31 shows an example of a computing device 3100 for document processing according to aspects of the present disclosure. The computing device 3100 may be an example of the document processing apparatus 1300 described with reference to FIG. 13. In one aspect, computing device 3100 includes processor(s) 3105, memory subsystem 3110, communication interface 3115, I/O interface 3120, user interface component(s) 3125, and channel 3130.

In some embodiments, computing device 3100 is an example of, or includes aspects of, the document processing model of FIG. 13. In some embodiments, computing device 3100 includes one or more processors 3105 that can execute instructions stored in memory subsystem 3110 to perform media generation.

According to some aspects, computing device 3100 includes one or more processors 3105. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 3110 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 3115 operates at a boundary between communicating entities (such as computing device 3100, one or more user devices, a cloud, and one or more databases) and channel 3130 and can record and process communications. In some cases, communication interface 3115 is provided to enable a processing system coupled to a transceiver (e.g., a transmitter and/or a receiver). In some examples, the transceiver is configured to transmit (or send) and receive signals for a communications device via an antenna.

According to some aspects, I/O interface 3120 is controlled by an I/O controller to manage input and output signals for computing device 3100. In some cases, I/O interface 3120 manages peripherals not integrated into computing device 3100. In some cases, I/O interface 3120 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 3120 or via hardware components controlled by the I/O controller.

According to some aspects, user interface component(s) 3125 enable a user to interact with computing device 3100. In some cases, user interface component(s) 3125 include an audio device, such as an external speaker system, an external display device such as a display screen, an input device (e.g., a remote-control device interfaced with a user interface directly or through the I/O controller), or a combination thereof. In some cases, user interface component(s) 3125 include a GUI.

FIG. 32 shows an example of a diffusion transformer (DiT) architecture according to aspects of the present disclosure. The example shown includes predicted noise 3205, predicted covariance 3210, linear and reshape layers 3215, normalization layer 3220, DiT block(s) 3225, patchify operation 3230, embedding 3235, noised latent 3240, timestep information 3245, label information 3250, and an implementation of one block in the DiT block(s) 3225 by a DiT block 3296. The DiT block 3296 includes: second residual connection 3260, second scaling operations 3262, feed-forward network 3264, post-normalization second scaling and shifting 3266, second normalization 3268, first residual connection 3270, first scaling operations 3272, self-attention 3274, post-normalization first scaling and shifting 3276, first normalization 3278, input tokens 3280, conditioning tokens 3282, multi-layer perceptron (MLP) 3284, post-normalization first scaling and shifting parameters 3286, first scaling parameter 3288, post-normalization second scaling and shifting parameters 3290, and second scaling parameter 3292. In some embodiments, the architecture employes an Latent Diffusion Transformer 3294. In some embodiments, DiT block 3296 employs an “adaLN-Zero” technique.

Diffusion Transformers (DiTs) is a popular architecture for diffusion models and is designed to be structurally faithful to standard transformer architecture. DiT incorporates transformer structures' scaling properties. For training denoising diffusion probabilistic models (DDPMs) of images (e.g., spatial representations of images), DiT is based on a Vision Transformer (ViT) architecture which operates on sequences of patches. DiT processes images by dividing them into patches, converting these patches into tokens, and applying attention mechanisms to model relationships between different regions of the image. This approach allows the model to capture both local and long-range dependencies in the image generation process.

In some cases, input to DiT is a spatial representation z. For 256×256×3 images, z has shape 32×32×4. A first layer of a DiT is to carry out patchify operation, where the DiT divides an input image into patches and converts the patches (a form of spatial input) into a sequence of T tokens, each of dimension d, by linearly embedding each patch in the input. Following the patchify process, ViT frequency-based positional embeddings are applied to all input tokens. In some cases, the number of tokens T created by patchify is determined by a patch size hyperparameter p. In some cases, T=(I/p)², where I is another shape parameter, thus halving p will quadruple T, which in some cases at least quadruples total of transformer Giga Floating Point Operations (Gflops). In some examples, changing p has no impact on downstream parameter counts, i.e., parameter counts in downstream layers of DiT is independent from p. In some examples, p=2, 4 or 8. Various patch sizes, transformer block architectures and model sizes are implemented.

Following Patchify operation, attention mechanisms are applied to model relationships between different regions of the image in one or more DiT blocks. In addition to noised image inputs, diffusion models sometimes process additional conditional information such as noise timesteps t, class labels c, natural language information, etc. Four variants of transformer blocks for processing conditional inputs including both input information and conditional information are described below.

In some cases, DiT blocks in the DiT network are implemented using adaptive layer norm (adaLN) blocks. Following adaptive normalization layers in generative adversarial networks (GANs) and conventional diffusion models with U-Net backbones, in some examples, standard normalization layers in transformer blocks are replaced with adaptive layer norm (adaLN). Rather than directly learning dimension-wise scale γ and shift parameters β, in adaLN the system regresses γ and β from a sum of the embedding vectors of the noise timesteps t and the class labels c. An adaLN adds relatively small numbers of Gflops and is more efficient. Additionally, adaLN is a conditioning mechanism that applies a same function to all tokens.

In some cases, DiT blocks in the DiT network are implemented using adaLN-Zero blocks, which leverages zero-initialization techniques. In Residual Networks (ResNets), initializing each residual block as the identity function x→x is beneficial. In some examples, zero-initializing a final batch norm scale factor γ in each block accelerates large-scale training in supervised learning settings. Diffusion models based on U-Nets use a similar initialization strategy, zero-initializing final convolutional layer in each block prior to residual connections. An adaLN-Zero block is modified from an adaLN block using similar zero-initialization techniques. In addition to regressing the dimension-wise scale γ and the shifting parameters β, the system also regresses dimension-wise scaling parameters as that are applied immediately prior to residual connections within the DiT block. The network initializes a multi-layer perceptron (MLP) to output a zero-vector for all as; this initializes an entire DiT block as the identity function. As with the adaLN block, adaLNZero adds negligible Gflops to the model.

In some cases, DiT blocks in the DiT network are implemented using in-context conditioning, where vector embeddings of t and c are appended as two additional tokens in the input sequence, and after a final block, the network removes the two conditioning tokens from the sequence.

In some cases, DiT blocks in the DiT network include cross-attention blocks. The DiT network concatenates the embeddings of t and c into a length-two sequence, separate from the image token sequence. The transformer block is modified to include an additional multi-head cross-attention layer following the multi-head self-attention block.

In some cases, the DiT network includes a sequence of N DiT blocks, each operating at a hidden dimension size d. Following ViT, the DiT network uses standard transformer configs that jointly scale N, d and attention heads. In some examples, Small(S), Base (B), Large (L) variants, XLarge (XL) variants of model sizes are implemented. Small or Base model sizes have N=12 layers of DiT blocks, Large model sizes have 24 layers of DiT blocks. XLarge model sizes have 28 layers of DiT blocks.

After a final DiT block, the DiT network decodes the sequence of image tokens into an output noise prediction and an output diagonal covariance prediction. Both outputs have shapes equal to an original spatial input. Standard linear decoder is utilized to decode, wherein a final normalization layer (or adaptive normalization layer if the DiT block is an adaLN block) and linearly decode each token into a p×p×2C tensor, where C is a number of channels in the spatial input to the DiT network and p is the patch size hyperparameter. Finally, decoded tokens are rearranged into their original spatial layout to get the predicted noise and covariance.

The DiT architecture, in some cases, employs a latent diffusion transformer 3294. The DiT architecture processes noised latent 3240, which may be a noised version of an input image encoded in a latent space. Patchify operation 3230 divides the noised latent into a sequence of patches that are processed as tokens. The tokens are vector representations of each patch of the image in latent space and are adjusted through attention processes. Each of the tokens also receives timestep information 3245 and label information 3250 and, accordingly, their embedding 3235, which encodes the current denoising timestep and class labels as conditional information. In some cases, embedding 3235 is referred to as conditional embedding or conditional information embedding. In some cases, a positional embedding which encodes each token's spatial position in the image is applied to the patchified input tokens at the patchify operations 3230. In some examples the positional embedding is ViT frequency-based positional embedding. The input tokens 3280 generated by the patchify operation 3230 and the conditioning tokens 3282 generated by the embedding 3235 are processed through N DiT block(s) 3225, where N may be 12, 24 or 28. Other values of N may be used. In some cases, conditional tokens refer to tokens generated based on embedding 135 encoding timestep information 3245 and label information 3250.

Each of the DiT block(s) 3225 includes multiple processing stages. DiT block 3296 illustrates an embodiment of one block in the DiT block(s) 3225. In some embodiments, the DiT block 3296 is an example of, or includes aspects of, the adaLN-Zero block. In some cases, input tokens 3280 interact with the conditioning tokens 3282 through multiple attention mechanisms. Particularly, after first normalization 3278 applied to the input tokens and MLP 3284 to the conditional tokens, MLP 3284 generates or updates post-normalization first scaling and shifting parameters 3286, denoted as γ₁, β₁, for post-normalization first scaling and shifting 3276 to scale and shift the output of first normalization 3278 accordingly. As the normalized input tokens obtained from first normalization 3278 are scaled and shifted at post-normalization first scaling and shifting 3276 using the conditional information carried as least in γ₁, β₁, this allows the input information and conditional information to interact. Self-attention 3274 allows the scaled and shifted normalized input tokens, namely the output from post-normalization first scaling and shifting 3276, to attend to each other. MLP 3284 also generates or updates first scaling parameter 3288 denoted as α₁ for first scaling operations 3272 to scale the output of self-attention 3274 (e.g., multi-head self-attention), further interacting the input information and conditional information. The input tokens 3280 is then summed with the output of first scaling operations 3272 at first residual connection 3270. In some examples, α₁ has initial values 0, and the DiT block 3296 is initialized as the identity function.

A similar process is performed in a second half of the DiT block 3296. MLP 3284 generates or updates post-normalization second scaling and shifting parameters 3290, denoted as γ₂, β₂, for post-normalization second scaling and shifting 3266 to scale and shift the output of second normalization 3268 accordingly. As the output from second normalization 3268 is scaled and shifted using the conditional information carried at least in γ₂, β₂, this allows the input information and conditional information to further interact. Feed-forward network 3264 then processes the scaled and shifted output from post-normalization second scaling and shifting 3266. MLP 3284 also generates or updates second scaling parameter 3292 denoted as α₂ for second scaling operations 3262 to scale the output of feed-forward network 3264, further interacting the input information and conditional information. In some cases, the feed-forward network 3264 is a pointwise feed-forward network. The output from first residual connection 3270 is then summed with the output of second scaling operations 3262 at second residual connection 3260, and the result is the final output of DiT block 3296. In some examples, α₂ has initial values 0, and the DiT block 3296 is initialized as the identity function. This process repeats for each DiT block in the sequence.

After processing through all DiT block(s) 3225, the outputs undergo normalization layer 3220 followed by linear and reshape layers 3215. The final output is the predicted noise 3205, which represents the model's prediction of the noise that was added to initially create the noised latent 3240, and the predicted covariance 3210, which represents the model's prediction of the covariance. The predicted noise 3205 is removed from noised latent 3240 at each diffusion timestep, and the predicted covariance may affect how noise is removed or resampled in the reverse or denoising process. At the end of the denoising schedule, the latent sample is decoded to generate the synthetic image in pixel space.

Performance of apparatus, systems and methods of the present disclosure have been evaluated, and results indicate embodiments of the present disclosure have obtained increased performance over conventional technology. Example experiments demonstrate that the document processing apparatus and machine learning model described in embodiments of the present disclosure outperforms conventional systems.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an image and a style guide, wherein the image depicts an object with a first color and the style guide includes a second color;
identifying a second color from the style guide based on a proximity criterion between the first color and the second color; and
generating, using an image generation model, a modified image based on the image and the second color, wherein the modified image depicts the object with the second color.

2. The method of claim 1, further comprising:
generating a first text description of the first color in the image; and
generating a second text description of the second color in the style guide, wherein the proximity criterion is based on the first text description and the second text description.

3. The method of claim 1, further comprising:
providing a style transformation element in a user interface; and
receiving a single click input via the style transformation element, wherein the modified image is generated based on the single click input.

4. The method of claim 1, further comprising:
identifying a color application parameter, wherein the second color is selected based on the color application parameter.

5. The method of claim 1, wherein:
the style guide comprises a font, a text color, a background color, a logo, or any combination thereof.

6. The method of claim 1, further comprising:
obtaining a document including the image; and
generating a modified document including the modified image.

7. The method of claim 6, further comprising:
receiving a page selection input; and
applying the style guide to a plurality of pages of the document based on the page selection input.

8. The method of claim 6, wherein generating the modified document comprises:
applying a first style attribute of the style guide to a first element of the document; and
applying a second style attribute of the style guide to a second element of the document.

9. The method of claim 6, wherein generating the modified document comprises:
applying a font from the style guide to a text element of the document.

10. The method of claim 1, further comprising:
generating a first color embedding representing the first color based on the image; and
generating a second color embedding representing the second color from the style guide, wherein the proximity criterion is based on a distance between the first color embedding and the second color embedding.

11. A non-transitory computer readable medium storing code for document processing, the code comprising instructions that, when executed by at least one processor, cause the at least one processor to perform operations comprising:
obtaining a document and a style guide, wherein the document includes a text element with a first font and an image depicting an object with a first color, and wherein the style guide includes a second font and a second color;
applying the second font from the style guide to the text element to obtain a modified text element;
applying, using an image generation model, the second color from the style guide to the image to obtain a modified image, wherein the modified image depicts the object with the second color; and
generating a modified document that includes the modified image and the modified text element.

12. The non-transitory computer readable medium of claim 11, the code further comprising instructions executable by the at least one processor to perform operations comprising:
generating a first text description of the first color in the image;
generating a first color embedding based on the first text description;
generating a second text description of the second color in the style guide; and
generating a second color embedding based on the second text description.

13. The non-transitory computer readable medium of claim 11, the code further comprising instructions executable by the at least one processor to perform operations comprising:
providing a style transformation element in a user interface; and
receiving a single click input via the style transformation element, wherein the modified image is generated based on the single click input.

14. The non-transitory computer readable medium of claim 11, the code further comprising instructions executable by the at least one processor to perform operations comprising:
applying a third font, which is different from the second font, from the style guide to an additional text element of the document to obtain an additional modified text element, wherein the modified document includes the additional modified text element.

15. The non-transitory computer readable medium of claim 11, the code further comprising instructions executable by the at least one processor to perform operations comprising:
receiving a page selection input; and
applying the style guide to a plurality of pages of the document based on the page selection input.

16. The non-transitory computer readable medium of claim 11, wherein generating the modified document comprises:
applying a first style attribute of the style guide to a first element of the document; and
applying a second style attribute of the style guide to a second element of the document.

17. A system comprising:
a memory component; and
a processing device coupled to the memory component, the processing device configured to perform operations comprising:
obtaining an image and a style guide, wherein the image depicts an object with a first color and the style guide includes a second color;
identifying a second color from the style guide based on a proximity criterion between the first color and the second color; and
generating, using an image generation model, a modified image based on the image and the second color, wherein the modified image depicts the object with the second color.

18. The system of claim 17, further comprising:
a language generation model configured to generate a first color embedding based on the first color and a second color embedding based on the second color.

19. The system of claim 17, wherein:
the image generation model is configured to generate the modified image as a synthetic image by applying the second color to the object.

20. The system of claim 17, wherein the processing device is further configured to perform operations comprising:
providing a style transformation element in a user interface; and
receiving a single click input via the style transformation element, wherein the modified image is generated based on the single click input.
